(19) United States
(12) Patent Application Publication
(10) Pub. No.: US 2025/0363819 A1
(43) Pub. Date: Nov. 27, 2025

(54) SYSTEMS AND METHODS FOR AUTOMATED INSPECTION OF VEHICLES FOR BODY DAMAGE

(71) Applicant: UVeye Ltd., Tel Aviv (IL)

(72) Inventors: Amir HEVER, Tenafly, NJ (US); Itai ORR, Or Akiva (IL)

(73) Assignee: UVeye Ltd., Tel Aviv (IL)

(21) Appl. No.: 19/291,622

(22) Filed: Aug. 6, 2025

Related U.S. Application Data
(63) Continuation-in-part of application No. 18/991,874, filed on Dec. 23, 2024.
Application No. 18/991,874 is a continuation-in-part of application No. 18/613,176, filed on Mar. 22, 2024, now Pat. No. 12,175,651.

(51) Int. Cl. G06V 20/00; G06F 40/103; G06F 40/20; G06F 40/40; G06V 10/25; G06V 10/70; G06V 20/70

(52) U.S. Cl. CPC G06V 20/95; G06F 40/103; G06F 40/20; G06F 40/40; G06V 10/25; G06V 10/70; G06V 20/70; G06V 2201/08

(57) ABSTRACT

There is provided a method of automatically detecting that a target image is deepfake, comprising: receiving authentic images depicting a vehicle with actual damage, receiving the target image depicting potential damage to the vehicle, feeding the target image into a machine learning (ML) model, obtaining a candidate set of human-readable text describing the potential damage to the vehicle, feeding the authentic images into the ML model, obtaining from the ML model, a ground truth set of human-readable text describing the actual damage to the vehicle depicted in the authentic images, computing a similarity metric indicating a difference between the potential damage described in the candidate set of human-readable text and the actual damage described in the ground truth set of human-readable text, and in response to the difference being above a threshold or meeting a requirement indicating a significant difference, detecting that the target image is likely deepfake.

### RELATED APPLICATION

This application is a Continuation-in-Part (CIP) of U.S. patent application Ser. No. 18/991,874 filed on Dec. 23, 2024, which is a CIP of U.S. patent application Ser. No. 18/613,176 filed on Mar. 22, 2024, now U.S. Pat. No. 12,175,651, the contents of which are incorporated herein by reference in their entirety.

### FIELD AND BACKGROUND

The present invention, in some embodiments thereof, relates to image processing and, more specifically, but not exclusively, to systems and methods for analyzing images for detecting damage to a vehicle.

Vehicles may be automatically inspected by a system, to detect damage, and defects, for example scratches and/or dents.

### SUMMARY

According to a first aspect, a computer implemented method of image processing for detection of damage on a vehicle, comprises: accessing a plurality of time-spaced image sequences depicting a region of a vehicle, captured by a plurality of image sensors positioned at a plurality of different views, identifying a plurality of candidate regions of damage in the plurality of time-spaced image sequences, performing a spatiotemporal correlation between the plurality of time-spaced image sequences, identifying redundancy in the plurality of candidate regions of damage corresponding to a common physical location of the vehicle denoting a single physical damage region, and providing an indication of the common physical location of the vehicle corresponding to the single physical damage region.

According to a second aspect, a system for image processing for detection of damage on a vehicle, comprises: at least one processor executing a code for: accessing a plurality of time-spaced image sequences depicting a region of a vehicle, captured by a plurality of image sensors positioned at a plurality of different views, identifying a plurality of candidate regions of damage in the plurality of time-spaced image sequences, performing a spatiotemporal correlation between the plurality of time-spaced image sequences, identifying redundancy in the plurality of candidate regions of damage corresponding to a common physical location of the vehicle denoting a single physical damage region, and providing an indication of the common physical location of the vehicle corresponding to the single physical damage region.

According to a third aspect, a non-transitory medium storing program instructions for image processing for detection of damage on a vehicle, which when executed by at least one processor, cause the at least one processor to: access a plurality of time-spaced image sequences depicting a region of a vehicle, captured by a plurality of image sensors positioned at a plurality of different views, identify a plurality of candidate regions of damage in the plurality of time-spaced image sequences, perform a spatiotemporal correlation between the plurality of time-spaced image sequences, identify redundancy in the plurality of candidate regions of damage corresponding to a common physical location of the vehicle denoting a single physical damage region, and provide an indication of the common physical location of the vehicle corresponding to the single physical damage region.

In a further implementation form of the first, second, and third aspects, the vehicle is moving relative to the plurality of image sensors, and the spatiotemporal correlation includes correlating between different images of different image sensors captured at different points in time.

In a further implementation form of the first, second, and third aspects, the identifying redundancy is performed for identifying a plurality of single physical damage regions within a common physical component of the vehicle.

In a further implementation form of the first, second, and third aspects, further comprising: analyzing the plurality of single physical damage regions within the common physical component of the vehicle, and generating a recommendation for fixing the common physical component.

In a further implementation form of the first, second, and third aspects, further comprising: classifying each of the plurality of single physical damage regions into a damage category, wherein analyzing comprises analyzing at least one of a pattern of distribution of the plurality of single physical damage regions and a combination of damage categories of the plurality of single physical damage regions.

In a further implementation form of the first, second, and third aspects, further comprising: iterating the identifying redundancy for identifying a plurality of single physical damage regions within a plurality of physical components of the vehicle, and generating a map of the plurality of physical components of the vehicle marked with respective location of each of the plurality of single physical damage regions.

In a further implementation form of the first, second, and third aspects, performing the spatiotemporal correlation comprises: computing a transformation between a first image captured by a first image sensor set at a first view and a second image captured by a second image sensor set at a second view different than the first view, wherein the first image depicts a first candidate region of damage, wherein the second image depicts a second candidate region of damage, applying the transformation to the first image to generate a transformed first image depicting a transformed first candidate region of damage, computing a correlation between the second candidate region of damage and the transformed first candidate region of damage, and wherein identifying redundancy comprises identifying redundancy of the first candidate region of damage and the second candidate region of damage when the correlation is above a threshold.

In a further implementation form of the first, second, and third aspects, the threshold indicates an amount of overlap of the second candidate region of damage and the transformed first candidate region of damage, at the common physical location.

In a further implementation form of the first, second, and third aspects, further comprising: detecting a plurality of features in the first image and in the second image, matching the plurality of features detected in the first image to the plurality of features detected in the second images, and wherein computing the transformation comprises computing the transformation according to the matched plurality of features.

In a further implementation form of the first, second, and third aspects, further comprising: segmenting the common physical location from the plurality of time-spaced image sequences, wherein the spatiotemporal correlation is performed for the segmented common physical locations of the plurality of time-spaced image sequences.

In a further implementation form of the first, second, and third aspects, further comprising: classifying each of the plurality of time-spaced images into a classification category indicating a physical component of the vehicle of a plurality of physical components, clustering the plurality of time-spaced images into a plurality of cluster of time-spaced images each corresponding to one of the plurality of physical components, wherein the spatiotemporal correlation and identifying redundancy are implemented for each cluster for providing the single physical damage region for each physical component of each cluster.

In a further implementation form of the first, second, and third aspects, performing the spatiotemporal correlation comprises performing the spatiotemporal correlation between: time-spaced images of a sequence of a same image sensor captured at different times, between time-spaced images sequences of different image sensors at different views overlapping at the common physical location of the vehicle captured at a same time, and between time-spaced images sequences of different image sensors overlapping at the common physical location of the vehicle captured at different times.

In a further implementation form of the first, second, and third aspects, performing a spatiotemporal correlation comprising: computing a predicted candidate region of damage comprising a location of where a first candidate region of damage depicted in a first image is to predicted to be located in a second image according to a time difference between capture of the first image and the second image, wherein the second image depicts a second candidate region of damage, computing a correlation between the predicted candidate region of damage and the second candidate region of damage, and wherein identifying redundancy comprises identifying redundancy of the first candidate region of damage and the second candidate region of damage when the correlation is above a threshold.

In a further implementation form of the first, second, and third aspects, the predicted candidate region of damage is computed according to a relative movement between the vehicle and at least one image sensor capturing the first image and second image, the relative movement occurring by at least one of the vehicle moving relative to the at least one image sensor and the at least one image sensor moving relative to the vehicle.

In a further implementation form of the first, second, and third aspects, the first image and the second image are captured by a same image sensor.

In a further implementation form of the first, second, and third aspects, further comprising creating a plurality of filtered time-spaced images by removing background from the plurality of time-spaced image sequences, wherein the background that is selected for removal doesn't move according to a predicted motion between the vehicle and the plurality of image sensors, wherein the identifying, the performing the spatiotemporal correlation, and the identifying redundancy are performed on the filtered time-spaced images.

In a further implementation form of the first, second, and third aspects, further comprising: selecting a baseline region of damage in one of the plurality of time-spaced images corresponding to the physical location of the vehicle, and ignoring candidate regions of damage in other time-spaced images that correlate to the same physical location of the vehicle as the baseline region of damage.

In a further implementation form of the first, second, and third aspects, further comprising: labelling as an actual region of damage the candidate regions of damage in other time-spaced images that do not correlate to the same physical location of the vehicle as the base line region of damage and are located in another physical location of the vehicle.

In a further implementation form of the first, second, and third aspects, further comprising: presenting, within a user interface, an image of the vehicle with at least one indication of damage, each corresponding to the single physical damage area at the common physical location of the vehicle, wherein the image of the vehicle is segmented into a plurality of components, receiving, via the user interface, a selection of a component of the plurality of components, and in response to the selection of the component, presenting, within the user interface, an indication of at least one detected region of damage to the selected component.

In a further implementation form of the first, second, and third aspects, each detected region of damage is depicted by at least one of: within a boundary and a distinct visual overlay over the damage.

In a further implementation form of the first, second, and third aspects, a single boundary may include a plurality of detected regions of damage corresponding to a single aggregated damage region.

In a further implementation form of the first, second, and third aspects, further comprising: in response to a selection of one of the detected regions of damage, via the user interface, presenting within the user interface, at least one parameter of the selected detected region of damage.

In a further implementation form of the first, second, and third aspects, the at least one parameter is selected from: type of damage, recommendation for fixing the damage, indication of whether component is to be replaced or not, physical location of the damage on the component, estimated cost for repair.

In a further implementation form of the first, second, and third aspects, further comprising: in response to a selection of one of the detected regions of damage, via the user interface, presenting via the user interface, an interactive selection element for selection by a user of at least one of: severity of the damage, and rejection or acceptance of the damage.

In a further implementation form of the first, second, and third aspects, further comprising: in response to a selection of one of the detected regions of damage, via the user interface, presenting via the user interface, an enlarged image of the selected region of damage, and automatically focusing on the damage within the selected region of damage.

In a further implementation form of the first, second, and third aspects, the plurality of components represent separate physically distinct components of the vehicle each of which is individually replaceable.

In a further implementation form of the first, second, and third aspects, further comprising: mapping the vehicle to one predefined 3D model of a plurality of predefined 3D models, wherein the plurality of components are defined on the 3D model, mapping the at least one detected region of damage to the plurality of components on the 3D model, and presenting, within the user interface, the 3D model with the at least one detected region depicted thereon.

According to a fourth aspect, a computer implemented method of image processing for detection of damage on a vehicle, comprises: accessing a plurality of time-spaced image sequences depicting a region of a vehicle, captured by a plurality of image sensors positioned at a plurality of different heights and/or angles relative to the vehicle, identifying a plurality of candidate regions of damage in the plurality of time-spaced image sequences, performing multi-level redundancy validation by: executing spatial correlation between images captured by different images sensors at different heights and/or different angles, executing temporal correlation between consecutive images captured by each image sensor, and validating persistence of each candidate region of damage across a threshold number of consecutive frames, identifying redundancy in the plurality of candidate regions of damage corresponding to a common physical location of the vehicle denoting a single physical damage region based on the multi-level redundancy validation, and providing an indication of the common physical location of the vehicle corresponding to the single physical damage region.

According to a fifth aspect, a system for image processing for detection of damage on a vehicle, comprises: at least one processor executing a code for: accessing a plurality of time-spaced image sequences depicting a region of a vehicle, captured by a plurality of image sensors positioned at a plurality of different heights and/or angles relative to the vehicle, identifying a plurality of candidate regions of damage in the plurality of time-spaced image sequences, performing multi-level redundancy validation by: executing spatial correlation between images captured by different images sensors at different heights and/or different angles, executing temporal correlation between consecutive images captured by each image sensor, and validating persistence of each candidate region of damage across a threshold number of consecutive frames, identifying redundancy in the plurality of candidate regions of damage corresponding to a common physical location of the vehicle denoting a single physical damage region based on the multi-level redundancy validation, and providing an indication of the common physical location of the vehicle corresponding to the single physical damage region.

According to a sixth aspect, non-transitory medium storing program instructions for image processing for detection of damage on a vehicle, which when executed by at least one processor, cause the at least one processor to: access a plurality of time-spaced image sequences depicting a region of a vehicle, captured by a plurality of image sensors positioned at a plurality of different heights and/or angles relative to the vehicle, identify a plurality of candidate regions of damage in the plurality of time-spaced image sequences, perform multi-level redundancy validation by: executing spatial correlation between images captured by different images sensors at different heights and/or different angles, executing temporal correlation between consecutive images captured by each image sensor, and validating persistence of each candidate region of damage across a threshold number of consecutive frames, identify redundancy in the plurality of candidate regions of damage corresponding to a common physical location of the vehicle denoting a single physical damage region based on the multi-level redundancy validation, and provide an indication of the common physical location of the vehicle corresponding to the single physical damage region.

In a further implementation form of the fourth, fifth, and sixth aspects, validating persistence of each candidate region of damage across a threshold number of consecutive frames comprises: tracking each respective candidate region of damage across a plurality of consecutive frames for identifying a number of frames of the plurality of consecutive frames for which each respective candidate region is detected, and designating the respective candidate region of damage as an actual region of damage when the number of frames in which the respective candidate region of damage appears is greater than the threshold number of consecutive frames.

In a further implementation form of the fourth, fifth, and sixth aspects, further comprising designating the respective candidate region of damage as transient visual artifacts when the number of frames in which the respective candidate region of damage appears is less than the threshold number of consecutive frames.

In a further implementation form of the fourth, fifth, and sixth aspects, further comprising: computing a confidence score for each candidate region of the plurality of candidate regions of damage, wherein the confidence score is computed according to at least one of: overlap, angle consistency, and damage characteristics, selecting a subset of the plurality of candidate regions of damage having confidence scores above a confidence threshold, and performing the multi-level redundancy validation for the subset of the plurality of candidate regions of damage.

In a further implementation form of the fourth, fifth, and sixth aspects, the confidence score is computed for a first candidate region of damage depicted in a first image according to overlap with at least one second candidate region of damage depicted in at least one second image registered to the first image.

In a further implementation form of the fourth, fifth, and sixth aspects, registration between the first image and the at least one second image is computed by mapping the first image and the at least one second image to a common coordinate system, wherein the overlap between the first candidate region of damage and the at least one second candidate region of damage is computed according to the common coordinate system.

In a further implementation form of the fourth, fifth, and sixth aspects, overlap comprises at least one of: similarity between size of the first candidate region and the at least one second candidate region, ratio of the first candidate region and the at least one second candidate region, and a distance between a center of the first candidate region and the at least one second candidate region.

In a further implementation form of the fourth, fifth, and sixth aspects, the confidence score takes into account partial visibility of the candidate region and/or errors in transformation between a first candidate region of damage depicted in a first image and at least one second candidate region of damage depicted in at least one second image.

In a further implementation form of the fourth, fifth, and sixth aspects, the angle consistency is computed by: computing a first pose of an image sensor that captured a first image depicting the respective candidate region of damage, computing a second pose of the image sensor that captured a second image depicting the respective candidate region of damage, and computing a similarity between the first pose and the second pose.

In a further implementation form of the fourth, fifth, and sixth aspects, the confidence score is based on damage characteristics indicating likelihood of actual damage versus artifacts for the respective candidate region of damage computed by analyzing at least one image depicting the respective candidate region of damage.

In a further implementation form of the fourth, fifth, and sixth aspects, executing spatial correlation comprises: analyzing each image of the images captured by different images sensors and depicting candidate regions of damage to identify at least one predefined marker, matching the at least one predefined marker detected in a first image captured by a first image sensor depicting a first candidate region of damage, to the at least one predefined marker detected in a second image captured by a second image sensor depicting a second candidate region of damage, wherein the matching is done in two dimensions, according to the two dimensional location of the candidate region of damage and intrinsic information of the different image sensors, computing a three dimensional mapping between a first pose of the first sensor and a second pose of the second sensor, and identifying redundancy by validating that the first candidate region of damage captured by the first image sensor is the same as the second candidate region of damage captured by the second image second according to the 3D mapping.

In a further implementation form of the fourth, fifth, and sixth aspects, the at least one predefined marker is selected from: a door, a window, a bumper, and a wheel.

In a further implementation form of the fourth, fifth, and sixth aspects, further comprising: analyzing each image of the images captured by different images sensors and depicting candidate regions of damage to identify lightening conditions, and dynamically adjusting an overlap threshold indicating amount of overlap between a first image captured by a first image sensor depicting a first candidate region of damage, and a second image captured by a second image sensor depicting a second candidate region of damage, wherein the overlap threshold is dynamically adjusted for accounting for shadow and/or reflection inconsistencies for reducing probability of misidentifying redundant damage regions.

In a further implementation form of the fourth, fifth, and sixth aspects, identifying redundancy comprises: analyzing each image depicting a candidate region of damage to identify a 3-point correlation comprising: time associated with the image, a pose of an image sensor capturing the image, and alignment of the image, and designating the image depicting the candidate region of damage as unique when the 3-point correlation associated with the image is non-correlated with another 3-point correlation of another image depicting the candidate region of damage.

In a further implementation form of the fourth, fifth, and sixth aspects, further comprising designating the image depicting the candidate region of damage as redundant when the 3-point correlation associated with the image is correlated with another 3-point correlation of another image depicting the candidate region of damage.

In a further implementation form of the first, second, and third aspects, further comprising: receiving via the user interface, instructions for rotating, displacement, and/or zoom in/out of the 3D model, and presenting the 3D model with implementation of the instructions.

According to a seventh aspect, a system for automatically detecting that at least one target 5 image depicting damage to a vehicle is generated or manipulated by deepfake technology, comprises: a plurality of image sensors positioned at a plurality of different heights and/or angles relative to the vehicle configured for capturing a plurality of authentic images depicting a vehicle with actual damage, a data interface configured to access and/or receive at least one target image depicting potential damage to the vehicle for evaluation of being deepfake, at least one processor configured for: feeding into a machine learning (ML) model, the at least one target image, obtaining from the machine learning model, a candidate set of human-readable text describing the potential damage to the vehicle depicted in the at least one target image, feeding into the ML model, the plurality of authentic images depicting the actual damage to the vehicle, obtaining from the ML model, a ground truth set of human-readable text describing the actual damage to the vehicle depicted in the authentic images, computing a similarity metric indicating a difference between the potential damage described in the candidate set of human-readable text and the actual damage described in the ground truth set of human-readable text, and in response to the difference being above a threshold or meeting a requirement indicating a significant difference, detecting that the at least one target image is likely deepfake.

According to an eighth aspect, method of automatically detecting that at least one target image depicting damage to a vehicle is generated or manipulated by deepfake technology, comprising: receiving a plurality of authentic images depicting a vehicle with actual damage captured by a plurality of image sensors positioned at a plurality of different heights and/or angles relative to the vehicle, receiving at least one target image depicting potential damage to the vehicle for evaluation of being deepfake, feeding into a machine learning (ML) model, the at least one target image, obtaining from the machine learning model, a candidate set of human-readable text describing the potential damage to the vehicle depicted in the at least one target image, feeding into the ML model, the plurality of authentic images depicting the actual damage to the vehicle, obtaining from the ML model, a ground truth set of human-readable text describing the actual damage to the vehicle depicted in the authentic images, computing a similarity metric indicating a difference between the potential damage described in the candidate set of human-readable text and the actual damage described in the ground truth set of human-readable text, and in response to the difference being above a threshold or meeting a requirement indicating a significant difference, detecting that the at least one target image is likely deepfake.

According to a ninth aspect, non-transitory medium storing program instructions for automatically detecting that at least one target image depicting damage to a vehicle is generated or manipulated by deepfake technology, comprising program instructions which when executed by at least one processor, cause the at least one processor to: receive a plurality of authentic images depicting a vehicle with actual damage captured by a plurality of image sensors positioned at a plurality of different heights and/or angles relative to the vehicle, receive at least one target image depicting potential damage to the vehicle for evaluation of being deepfake, feed into a machine learning (ML) model, the at least one target image, obtain from the machine learning model, a candidate set of human-readable text describing the potential damage to the vehicle depicted in the at least one target image, feed into the ML model, the plurality of authentic images depicting the actual damage to the vehicle, obtain from the ML model, a ground truth set of human-readable text describing the actual damage to the vehicle depicted in the authentic images, compute a similarity metric indicating a difference between the potential damage described in the candidate set of human-readable text and the actual damage described in the ground truth set of human-readable text, and in response to the difference being above a threshold or meeting a requirement indicating a significant difference, detect that the at least one target image is likely deepfake.

In a further implementation form of the seventh, eighth, and ninth aspects, the at least one processor is further configured for: in response to the generated indication that the at least one target image is likely deepfake, feeding the at least one target image into a deepfake detection process that analyzes the at least one target image to confirm that the at least one target image is deepfake.

In a further implementation form of the seventh, eighth, and ninth aspects, the at least one processor is further configured for: generative a cryptographic digital fingerprint indicating authenticity associated with the plurality of authentic images, and for confirming presence of the cryptographic digital fingerprint for validating authenticity of the plurality of authentic images prior to feeding into the ML model.

In a further implementation form of the seventh, eighth, and ninth aspects, the data interface is further configured to access and/or receive a target human-readable text description of the potential damage, wherein the target human-readable text description of the potential damage is fed into the ML model in combination with the at least one target image.

In a further implementation form of the seventh, eighth, and ninth aspects, the ML model generates at least one of the following in response to an input image depicting damage to the vehicle: (i) an indication of severity of damage depicted in the input image, (ii) a recommendation for repair of the damage, and (iii) an estimated cost for repairing the damage.

In a further implementation form of the seventh, eighth, and ninth aspects, the similarity metric is computed by feeding the potential damage described in the candidate set of human-readable text and the actual damage described in the ground truth set of human-readable text into a second ML model trained to generate an outcome indicating whether two inputs are similar or not and/or generate an indication of a level of dissimilarity.

In a further implementation form of the seventh, eighth, and ninth aspects, the second ML model is implemented as a large language model (LLM), wherein a prompt is fed into the LLM for instructing the LLM model to identify and describe the difference between the potential damage described in the candidate set of human-readable text and the actual damage described in the ground truth set of human-readable text

In a further implementation form of the seventh, eighth, and ninth aspects, in response to an input image depicting damage, the ML model generates an outcome of a set of human-readable text describing the potential damage according to a predefined format and/or template selected for improving accuracy of computing the similarity metric.

In a further implementation form of the seventh, eighth, and ninth aspects, the ML model is trained on a training dataset of a plurality of records, wherein a record includes at least one image of a sample vehicle indicating sample damage, and a ground truth including a set of human-readable text elements describing the damage.

In a further implementation form of the seventh, eighth, and ninth aspects, the at least one processor is further configured for: accessing a historical set of authentic images of the vehicle depicting pre-existing damage or lack of damage, feeding into the ML model, the historical set of authentic images, obtaining from the ML model, a historical set of human-readable text describing pre-existing damage to the vehicle or lack of damage to the vehicle, computing a second similarity metric indicating similarity between the pre-existing damage or lack of damage of the vehicle described in the historical set of human-readable text and the actual damage described in the ground truth, and (i) in response to the second similarity metric being above a threshold, confirming the presence of pre-existing damage to the vehicle, or (ii) in response to the second similarity metric being below the threshold, confirming the lack of pre-existing damage to the vehicle.

In a further implementation form of the seventh, eighth, and ninth aspects, the at least one processor is further configured for: selecting at least one image of the plurality of authentic image depicting at least one region of the vehicle with damage not depicted in the at least one target image, analyzing the selected at least one image for compliance with a damage pattern depicted by the at least one target image, and in response to detecting that the damage in the at least one region of the selected at least one image is inconsistent with and/or contradicts the damage pattern depicted by the at least one target image, detecting that the at least one target image is likely deepfake.

In a further implementation form of the seventh, eighth, and ninth aspects, the at least one region comprises an undercarriage captured by at least one image sensor positioned for capturing images depicting the undercarriage of the vehicle.

In a further implementation form of the seventh, eighth, and ninth aspects, the analyzing is performed by: feeding the selected at least one image into the ML model, obtaining from the ML model, a second ground truth set of human-readable text describing the damage in the at least one region not depicted in the at least one target image, and analyzing the second ground truth set with respect to the candidate set by at least one of: feeding into a second ML model and/or a LLM trained on a plurality of records where each record includes a description of a damage pattern and an indication of whether the damage pattern is likely or unlikely, a set of rules defining likely or unlikely damage patterns, feeding the second ground truth set and the candidate set into a model that simulates an accident according to input.

In a further implementation form of the seventh, eighth, and ninth aspects, the plurality of authentic images comprise a plurality of time-spaced image sequences, wherein the at least one processor is further configured for: identifying a plurality of candidate regions of damage in the plurality of time-spaced image sequences, performing multi-level redundancy validation by: executing spatial correlation between images captured by different images sensors at different heights and/or different angles, executing temporal correlation between consecutive images captured by each image sensor, and validating persistence of each candidate region of damage across a threshold number of consecutive frames, identifying redundancy in the plurality of candidate regions of damage corresponding to a common physical location of the vehicle denoting a single physical damage region based on the multi-level redundancy validation, and selecting at least one authentic image from the plurality of time-spaced image sequences depicting the common physical location of the vehicle corresponding to the single physical damage region, wherein the selected at least one authentic image is fed into the ML model to obtain the ground truth set.

In a further implementation form of the seventh, eighth, and ninth aspects, the plurality of authentic images comprise a plurality of time-spaced image sequences, wherein the at least one processor is further configured for: identifying a plurality of candidate regions of damage in the plurality of time-spaced image sequences, performing a spatiotemporal correlation between the plurality of time-spaced image sequences, identifying redundancy in the plurality of candidate regions of damage corresponding to a common physical location of the vehicle denoting a single physical damage region, and selecting at least one actual image from the plurality of time-spaced image sequences depicting the common physical location of the vehicle corresponding to the single physical damage region, wherein the selected at least one actual image is fed into the ML model to obtain the ground truth set.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of image processing for detection of damage on a vehicle by identifying redundancy of candidate regions in images, in accordance with some embodiments of the present invention;

FIG. 2 is a block diagram of components of a system 200 for image processing for detection of damage on a vehicle by identifying redundancy of candidate regions in images, in accordance with some embodiments of the present invention;

FIG. 3 is a schematic depicting spatial correlation of images of a vehicle, in accordance with some embodiments of the present invention;

FIG. 4 is a schematic depicting temporal correlation of images of a vehicle, in accordance with some embodiments of the present invention;

FIG. 5 is a flowchart of a method of operating a user interface, optionally an interactive GUI, presenting identified physical damage regions on a vehicle, in accordance with some embodiments of the present invention;

FIG. 6 is a schematic of exemplary views of a 3D model of a vehicle presented within a UI, in accordance with some embodiments of the present invention.

FIG. 7 includes exemplary images of regions of a vehicle with marked detected regions of damage, in accordance with some embodiments of the present invention.

FIG. 8 includes schematics depicting different views and/or zoom levels of a region of a car with damage, in accordance with some embodiments of the present invention;

FIG. 9 includes schematic depicting various levels of interaction with an identified region of damage on a vehicle, in accordance with some embodiments of the present invention;

FIG. 10 includes examples of an image of a vehicle without damage and a deepfake image depicting the vehicle with damage created by adapting the image of the vehicle without damage, in accordance with some embodiments of the present invention;

FIG. 11 is a flowchart of an exemplary high-level method for detection of deepfake data depicting damage to a vehicle, in accordance with some embodiments of the present invention;

FIG. 12 is a flowchart of a method for detection of a deepfake image(s) depicting damage to a vehicle, in accordance with some embodiments of the present invention;

FIG. 13 is a flowchart of a method for detection of pre-existing damage to a vehicle, in accordance with some embodiments of the present invention; and

FIG. 14 is a flowchart of a method for detection of a deepfake image(s) based on a damage pattern, in accordance with some embodiments of the present invention.

### DETAILED DESCRIPTION

The present invention, in some embodiments thereof, relates to image processing and, more specifically, but not exclusively, to systems and methods for analyzing images for detecting damage to a vehicle.

As used herein, the term vehicle may refer to a car, for example, sedan, sports car, minivan, SUV, and the like. However, it is to be understood that embodiments described herein may be used to detect damage in other vehicles, for example, buses, hulls of boats, and aircraft.

As used herein the term deepfake refers to the use of artificial intelligence (AI) tools, such as generative AI (GenAI) models, to adapt existing documents and/or images and/or videos such as to depict damage (e.g., which is being claimed from an insurance company) or to change the license plate on a damaged vehicle (e.g., to another vehicle without actual damage to pretend the undamaged vehicle is damaged), or to create entirely new data, such as documents, images and/or videos, which have not previously existing, such as a fake accident report (e.g., leading to the damage being claimed) and/or a fake invoice for repairs (e.g., of the non-existent damage being claimed).

An aspect of some embodiments of the present invention relates to systems, methods, computing devices, and/or code instructions (e.g., stored on a data storage device and executable by one or more processors) for automatically detecting that at least one target image depicting damage to a vehicle is generated or manipulated by deepfake technology, for example, part of a fraudulent insurance claim regarding non-existent damage to the vehicle. Multiple authentic images depicting a vehicle with actual damage are received (e.g., accessed). The image are captured by image sensors positioned at a different heights and/or different angles (i.e., different poses) relative to the vehicle. One or more target images depicting potential damage to the vehicle are received, for evaluation of being deepfake. The target image(s) may be submitted as part of an insurance claim for the damage depicted in the target image(s). The target image(s) are fed into a machine learning (ML) model. A candidate set of human-readable text describing the potential damage to the vehicle depicted in the target image(s) is obtained from the machine learning model. The authentic images depicting the actual damage to the vehicle are fed into the ML model, i.e., into the same model into which the target image(s) were fed. A ground truth set of human-readable text describing the actual damage to the vehicle depicted in the authentic images is obtained from the ML model. A similarity metric indicating a difference between the potential damage described in the candidate set of human-readable text and the actual damage described in the ground truth set of human-readable text, is computed. In response to the similarity metric, i.e., the difference, being above a threshold or meeting a requirement indicating a significant difference, the target image(s) is identified as likely being deepfake. Further investigation may be performed to determine whether the insurance claim is fraudulent, for example, feeding the target image(s) into an automated deepfake detector trained to detect whether an image was created or manipulated by a deepfake tool, and/or fed into another process for automatically detecting insurance fraud, and/or forwarded for manual review.

At least one embodiment described herein address the technical problem of identifying deepfake images depicting fake damage to a vehicle, for example, being submitted as part of an insurance fraud. The images depict damage to the vehicle where no real damage exists. At least one embodiment described herein improves the technology of detecting deepfake images, by detecting deepfake images depicting fake damage to the vehicle (i.e., the damage does not exist physically on the vehicle). At least one embodiment described herein improves upon prior approaches of detecting deepfake images depicting fake damage to a vehicle during insurance fraud, for example, manual inspection by a domain expert, indirect detection such as inconsistencies in the description of the accident, and the like. At least one embodiment described herein provides the practical application of detecting deepfake images depicting fake damage to a vehicle, and identifying an attempt an insurance fraud based on the deepfake images.

Generative AI is supercharging insurance fraud by making it easier to falsify accident evidence at scale and in rapid time. Insurance fraud is a pervasive and costly problem, amounting to tens of billions of dollars in losses each year. In the vehicle insurance sector, fraud schemes have traditionally involved staged accidents, exaggerated damage, or forged documents. The rise of generative AI, including deepfake image and video generation, has introduced new methods for committing fraud at scale. Fraudsters can now fabricate highly realistic crash photos, damage evidence, and even fake identities or documents with minimal effort, exploiting AI tools to bolster false insurance claims. Insurers have begun deploying countermeasures such as AI-based deepfake detection software and enhanced verification processes to detect and mitigate these AI-driven scams. However, current mitigation strategies face significant limitations. Detection tools can suffer from false positives and negatives, and sophisticated fraudsters continuously adapt their tactics to evade automated checks. This cat-and-mouse “arms race” between generative AI and detection technology, combined with resource and cost barriers for insurers, means that combating AI-enabled insurance fraud remains an ongoing challenge.

Insurance fraud is a massive and persistent problem, costing the United States economy hundreds of billions of dollars each year. A recent analysis estimated that over $308 billion is lost annually to insurance fraud across all lines—roughly one quarter of the industry's total value (Vekiarides, Nicos. “Viewpoint: Deepfake Fraud Is On the Rise. Here's How Insurers Can Respond.” Insurance Journal, 17 Jul. 2024, accessible at https://www.insurancejournal.com/news/national/2024/07/17/784226.htm). Within the property and casualty sector (which includes auto insurance), fraud losses are about $45 billion per year, effectively adding as much as $700 in extra premiums to each American family's annual insurance costs (Hattle-Cleminshaw, Ashley. “Fraudsters using AI to manipulate images for false claims.” propertycasualty360, 8 May 2024, accessible at https://www.propertycasualty360.com/2024/05/08/fraudsters-using-ai-to-manipulate-images-for-false-claims/).

Vehicle insurance claims have long been a target for fraud through tactics like staged accidents and inflated repair bills. Now, the emergence of generative AI has dramatically expanded the scale and sophistication of this threat. Generative AI tools can produce highly realistic fake images, videos, and documents with minimal skill or effort, lowering the barrier for would-be fraudsters to manufacture convincing evidence of vehicle damage. Indeed, insurers report a surge of AI-assisted fake claims: for example, in the UK, one major carrier observed a 300% increase in cases of doctored auto accident photos in just a one-year period (Jones, Rupert. “Fraudsters editing vehicle photos to add fake damage in UK insurance scam.” The Guardian, 2 May 2024, accessible at https://www.theguardian.com/business/article/2024/may/02/car-insurance-scam-fake-damaged-added-photos-manipulated). Such “deepfake” or “shallowfake” manipulations of claim evidence are blurring the line between fact and fiction, potentially leading to enormous fraud losses if unchecked. The industry's ongoing push toward automated, “touchless” claim processing further amplifies the risk. It is projected that 70% of standard insurance claims will be handled with little or no human intervention by 2025 (Vekiarides). This efficiency gain also creates a perilous scenario as AI-manipulated images or videos could be automatically accepted by AI-driven claims systems, or bypass past traditional anti-fraud controls.

One emblematic case involves the use of AI tools to forge photographic evidence of a car accident that never happened. In late 2023, investigators uncovered a fraudulent claim in which scammers had lifted a photo of a van from the owner's social media page and digitally edited it to add realistic-looking collision damage on the front bumper (Growcoot, Matt. “Fraudsters Are Editing Photos of Damaged Vehicles to Claim Insurance.” petapixel, 2024, accessible at https://petapixel.com/2024/05/07/fraudsters-are-editing-photos-of-damaged-vehicles-to-claim-insurance/). The falsified image depicted a cracked bumper and was submitted to the insurer along with a fake repair invoice for over $1,000 in purported damages. In reality, the van had not been in any accident—the image had been seamlessly altered using generative AI-powered photo editing to create the illusion of a crash. The insurer (LV=, a UK affiliate of Allianz) grew suspicious and investigated. Tellingly, they discovered the original intact photo of the van on the policyholder's social media, identical in every way except for the added bumper cracks (Jervis, Tom. “AI drives a major rise in car insurance fraud as criminals fake evidence.” auto express, 2024, accessible at https://www.autoexpress.co.uk/news/363070/ai-drives-major-rise-car-insurance-fraud-criminals-fake-evidence#:˜:text=One%20example%20of%20a%20doctored,submitted%20photograph%20had%20been%20doctored). This confirmed that the claim was entirely fabricated. The attempt was thwarted, but it exemplifies how easily fraudsters can now produce photographic ‘evidence’ of vehicle damage out of thin air.

Another emerging scheme involves using AI to concoct entire fictitious crash scenarios by repurposing real images of wrecked cars. In the UK, Zurich Insurance reports a trend in which fraud rings locate photographs of vehicles that were actually totaled in unrelated incidents (often found on salvage auction websites) and then use editing tools to implant a different license plate number onto the wreckage (Jones, Jervis). The modified image makes it appear that a car belonging to the fraudster was destroyed in a crash, when in fact the vehicle in the photo is someone else's loss. Armed with these fake photos, the fraudsters file “owner” claims for total loss compensation on vehicles that were never in any accident at all. “We have seen an increase in people locating total loss vehicles on salvage sites and then implanting a registration number onto that car. There are then claims made for that vehicle, and a claims handler would take it at face value—that it is that actual vehicle,” explains the head of claims fraud at Zurich UK, describing this modus operandi. Such schemes effectively combine identity theft of vehicle identities with AI-assisted image manipulation, yielding entirely fabricated claims that can be difficult to detect if an adjuster simply trusts the photo and plate number. In one instance, criminals pursued a claim in an innocent person's name using a doctored image of his business van taken from the internet. Only by digging into the image's provenance did investigators reveal the deception. These cases underscore that generative technology now enables “crash-for-cash” scams to be executed digitally, without any real collision-fraudsters can simulate the aftermath of an accident purely through pixels and paperwork.

Insurers are deploying a range of techniques to identify and counter generative AI-enabled vehicle insurance fraud, yet each approach has notable limitations. AI-based image forensics tools, including machine learning models designed to detect synthetic or manipulated images, have shown promise but remain far from foolproof. Many state-of-the-art deepfake detectors still struggle with reliability and generalization to novel forgeries (Kaur, Achhardeep, et al. “Deepfake video detection: challenges and opportunities.” Artificial Intelligence Review, vol. 57, no. 159, 2024, pp. 1-47. Artificial Intelligence Review, accessible at https://link.springer.com/article/10.1007/s10462-024-10810-6#:˜:text=These%20findings%20reflect%20the%20genuine,reliability%2C%20generalisation%2C%20and%20computing%20complexity). As generative models evolve to produce more photorealistic outputs, forensic algorithms often lag behind, leading to an ongoing “arms race” between fraudsters and detectors (Kotoulas, Yiannis. “TechTalk: Insurance fraud and the AI arms race.” insurance times, 2025, accessible at https://www.insurancetimes.co.uk/analysis/techtalk-insurance-fraud-and-the-ai-arms-race/1454548.article). These AI-driven detection systems are also resource-intensive and require continual updates with new training data to recognize emerging manipulation techniques, which can be costly and operationally challenging (Needham, Ruth, et al. “Deepfakes in the insurance market-a personal injury perspective.” kennedyslaw, 2024, accessible at https://kennedyslaw.com/en/thought-leadership/article/2024/deepfakes-in-the-insurance-market-a-personal-injury-perspective/). In practice, insurers find that certain AI-fabricated damage images can evade even advanced forensic checks, necessitating human expertise for final judgment.

Another traditional anti-fraud measure is metadata analysis of submitted photographs. Claims investigators routinely examine EXIF metadata (such as timestamps, GPS coordinates, or camera model) for inconsistencies that might signal tampering. However, this method has significant shortcomings against AI-generated content. By default, many AI-synthesized images lack the typical metadata fingerprint of an authentic camera capture (Knutsson, Kurt. “10 telltale signs of AI-created images.” 21 Fox News, March 2025, accessible at https://www.foxnews.com/tech/10-telltale-signs-ai-created-images). Even when metadata is present, it can be easily stripped or falsified by fraudsters using readily available tools, rendering it an unreliable indicator of authenticity (Pytech Academy. “AI-Generated Fraud is here: Fake Car Damage, Receipts, and IDs are just the Beginning.” pytech academy, 2025, accessible at https://pytechacademy.medium.com/ai-generated-fraud-is-here-fake-car-damage-receipts-and-ids-are-just-the-beginning-1cac03103a6a#:˜:text=,AI). For example, a claimant could remove location coordinates or alter date stamps to mask the origin of an AI-generated damage photo. Because an absence or irregularity of metadata is not definitive proof of fraud—legitimate photos might lose metadata through normal processing—this technique yields at best a weak signal and can produce both false positives and false negatives.

Insurers have also introduced workflow adjustments to mitigate the deepfake threat, such as requiring additional documentation, manual reviews, or in-person inspections for suspicious claims. While these procedural changes can deter some fraudulent attempts, they also slow down claim processing and inflate administrative costs (Needham et al.). In an era where a majority of standard claims are now handled in a “touchless” automated fashion (Vekiarides), imposing manual checks undermines customer experience and scalability. Furthermore, relying on human adjusters to spot AI-crafted forgeries is increasingly difficult as the fakes become nearly indistinguishable from real evidence (Kotoulas). Even highly trained experts can be deceived by high-quality synthetic images, so purely manual safeguards provide imperfect protection; moreover, insurers cannot simply add unlimited verification steps without unduly burdening legitimate claimants.

Industry collaboration has emerged as an important strategy, with insurers sharing information on suspected fraud cases and collectively developing countermeasures. Initiatives such as cross-company fraud databases and image-sharing repositories can help identify repeat offenders and detect scam patterns across insurers. However, this collaborative approach faces its own hurdles. Data sharing between companies remains limited-siloed information systems and privacy constraints impede a seamless exchange of fraud intelligence (synectics solutions. “Commercial Insurance Fraud in 2024: State of the Industry.” synectics solutions, 2024, accessible at https://www.synectics-solutions.com/our-thinking/commercial-insurance-fraud-in-2024_state-of-the-industry#:˜:text=2.%20Data%20management%3A%2080,hindering%20detection%20of%20fraudulent%20activities). Not all carriers are equally willing or able to contribute data, due to competitive sensitivities and legal restrictions on customer information. As a result, fraudsters may exploit gaps between organizations—for instance, recycling the same AI-fabricated claim at multiple insurers that do not communicate in real time. The lack of standardization and real-time coordination means the industry's defense against generative AI fraud is only as strong as its weakest link. While significant efforts are underway to adapt to AI-enabled insurance fraud, current detection and mitigation methods each have inherent limitations that leave insurers struggling to keep pace with increasingly sophisticated fraudulent techniques.

At least one embodiment provides a robust and comprehensive solution for detecting deepfake data (e.g., images, video, documents, text) for preventing vehicle claim fraud. Approaches described herein not only protect insurance companies from financial loss but also help to maintain the integrity of the insurance industry as a whole.

At least one embodiment described herein solved the aforementioned technical problem, and/or improves the aforementioned technical field, and/or improves upon the aforementioned technical approaches, and/or provides the practical application of detecting a deepfake image(s) part of an attempt an insurance fraud, by receiving multiple authentic images depicting a vehicle with actual damage. The image are captured by image sensors positioned at a different heights and/or different angles (i.e., different poses) relative to the vehicle. One or more target images depicting potential damage to the vehicle are received, for evaluation of being deepfake. The target image(s) may be submitted as part of an insurance claim for the damage depicted in the target image(s). The target image(s) are fed into a machine learning (ML) model. A candidate set of human-readable text describing the potential damage to the vehicle depicted in the target image(s) is obtained from the machine learning model. The authentic images depicting the actual damage to the vehicle are fed into the ML model, i.e., into the same model into which the target image(s) were fed. A ground truth set of human-readable text describing the actual damage to the vehicle depicted in the authentic images is obtained from the ML model. A similarity metric indicating a difference between the potential damage described in the candidate set of human-readable text and the actual damage described in the ground truth set of human-readable text, is computed. In response to the similarity metric, i.e., the difference, being above a threshold or meeting a requirement indicating a significant difference, the target image(s) is identified as likely being deepfake. Further investigation may be performed to determine whether the insurance claim is fraudulent, for example, feeding the target image(s) into an automated deepfake detector trained to detect whether an image was created or manipulated by a deepfake tool, and/or fed into another process for automatically detecting insurance fraud, and/or forwarded for manual review.

Generative AI has rapidly accelerated the sophistication and scale of vehicle insurance fraud. Fraudsters now easily fabricate damaged photos, videos, and documents, undermining traditional claim verification processes. While insurers have deployed AI detection tools, metadata checks, and manual reviews, each method faces limitations: evolving AI models evade forensic detection, metadata can be stripped or falsified, and human reviews are costly and error prone. Industry collaboration helps but remains fragmented, leaving critical gaps.

At least one embodiment offers a transformative defense. By anchoring insurance claims to physical, multi-frame, multi-camera scans, insurers gain objective, tamper-proof evidence of vehicle condition. The embedded encrypted fingerprint in scan data may further secure authenticity, detecting any attempt at post-scan tampering. As a trusted third party, an entity utilizing at least one embodiment adds independent verification to insurer workflows, reducing reliance on claimant-provided photos or documents susceptible to manipulation.

Beyond detection, at least one embodiment may provide a deterrent. Knowing insurance claims will face automated, impartial inspection discourages fraud attempts from the outset, while genuine insurance claims benefit from faster, more reliable resolution. Integrated at key points—policy issuance, post-accident assessment, repair validation—at least one embodiment strengthens fraud defenses while improving customer experience.

By embedding objective physical verification into the heart of claims processing, at least one embodiment offers insurers a scalable path to reduce fraud, lower costs, and restore trust in the claims process—turning the tide against the growing threat of generative AI.

One or more potential advantages provided by one or more embodiments described herein include:
1. Verification of claimed damage: Physical scans of the vehicle by multiple cameras capturing images of different regions of the vehicle at different poses, offer insurers an objective benchmark, immediately verifying whether claimed damages exist. Deepfake or edited claimant photos cannot alter the real-world state of the vehicle. This prevents payouts on fabricated claims and discourages fraud attempts relying solely on manipulated media
2. Baseline vehicle records: Pre-policy or pre-claim scans of the vehicle (i.e., by the multiple cameras capturing images of different regions of the vehicle at different poses) create a verifiable condition history, allowing insurers to identify pre-existing damage and prevent customers from falsely attributing old issues to new incidents. Automated image comparisons between pre- and post-incident scans highlight discrepancies clearly.
3. Post-accident damage assessment: Following an incident, the scan delivers a comprehensive and unbiased damage report, ensuring claim accuracy and reducing inflated estimates from repairers or claimants. The AI model may map damage severity to streamline claim settlements.
4. Detection of staged or exaggerated claims: Physical inconsistencies that reveal staged events, such as undercarriage scraping that contradicts an accident narrative or damage patterns inconsistent with the described collision, may be uncovered. These insights help differentiate genuine claims from orchestrated fraud.
5. Reducing reliance on claimant evidence: By incorporating scans into claims workflows, insurers reduce dependency on customer-submitted photos, which are increasingly unreliable due to deepfakes and image manipulation. At least one embodiment provides trusted, tamper-proof evidence, enhancing claims integrity.
6. Scalable integration: Systems based on at least one embodiment described herein are easily deployed at dealerships and inspection centers and can be integrated at preferred repair networks or mobile units for field use. Secured cloud-based data sharing allows insurers to instantly access inspection results, cross-reference historical scans, and embed findings directly into claims management systems.

An aspect of some embodiments of the present invention relates to systems, methods, computing devices, and/or code instructions (e.g., stored on a data storage device and executable by one or more processors) for processing of multiple images for detection of damage to (e.g., on) a vehicle, optionally for damage to a body of the vehicle such as the doors, hood, roof, bumper, and head/rear lights, for example, scratches and/or dents. Multiple time-spaced image sequences depicting a region of a vehicle are accessed. The multiple time-spaced image sequences are captured by multiple image sensors (e.g., cameras) positioned at multiple different heights and/or angles (i.e., views) relative to the vehicle. Each image sensor may capture a sequence of images captured at different times, for example, frames captured at a defined frame rate. Multiple candidate regions of damage are identified in the time-spaced image sequences, for example, by feeding the images into a detector machine learning model trained to detect damage. It is undetermined whether the multiple candidate regions of damage represent different physical regions of damage, or correspond to the same physical region of damage. A multi-level redundancy validation is performed as follows. A spatial correlation is executed between images captured by different image sensors at different heights and/or different angles. A temporal correlation is executed between consecutive images captured by each image sensor. Persistence of each candidate region of damage across a threshold number of consecutive frames is validated. The temporal correlation is executed between images (e.g., frames) captured by a same image sensor at different times. The spatial correlation is executed between images (e.g., frames) captured by different image sensors each set at a different height and/or angle. Redundancy is identified based on the multi-level redundancy validation, for the candidate regions of damage corresponding to a common physical location of the vehicle denoting a single physical damage region.

An aspect of some embodiments of the present invention relates to systems, methods, computing devices, and/or code instructions (e.g., stored on a data storage device and executable by one or more processors) for processing of multiple images for detection of damage on a vehicle, optionally for damage to a body of the vehicle such as the doors, hood, roof, bumper, and head/rear lights, for example, scratches and/or dents. Multiple time-spaced image sequences depicting a region of a vehicle are accessed. The multiple time-spaced image sequences are captured by multiple image sensors (e.g., cameras) positioned at multiple different views. Each image sensor may capture a sequence of images captured at different times, for example, frames captured at a defined frame rate. Multiple candidate regions of damage are identified in the time-spaced image sequences, for example, by feeding the images into a detector machine learning model trained to detect damage. It is undetermined whether the multiple candidate regions of damage represent different physical regions of damage, or correspond to the same physical region of damage. A spatiotemporal correlation is performed between the time-spaced image sequences. The spatiotemporal correlation includes a time correlation and a spatial correlation, which may be computed using different processing pipelines, optionally in parallel. The time correlation is performed between images (e.g., frames) captured by a same image sensor at different times. The spatial correlation is performed between images (e.g., frames) captured by different image sensors each set at a different view. Redundancy is identified for the candidate regions of damage corresponding to a common physical location of the vehicle denoting a single physical damage region.

Examples of redundancy identification include: for two overlapping images captured by two different cameras at two different views, each image depicting a respective candidate region of damage, redundancy may be identified indicating that the candidate regions of damage in the images captured by the two image sensors represent the same physical damage region. In another example, for two images captured by the same camera at different times (e.g., 1 second apart, 3 seconds apart, or other values), each image depicting a respective candidate region of damage, redundancy may be identified indicating that the candidate regions of damage in the images captured at different times represent the same physical damage region. For each of the aforementioned examples, the identified redundancy indicates there is a single physical damage region, rather than multiple damaged regions.

An indication of the common physical location of the vehicle corresponding to the single physical damage region is provided, for example, presented on a display, optionally within a user interface such as a graphical user interface (GUI). The GUI may be designed to enable the user to interact with the image depicting the physical damage reason, for example, to obtain more information in response to selection of the damage on an image.

At least some embodiments described herein address the technical problem of identifying damage to a vehicle, optionally to the body of the vehicle, for example, dents and/or scratches. Images of the vehicle are captured by multiple cameras arranged at different heights and/or angles (also referred to herein as views) relative to the vehicle, for capturing images depicting different surfaces of the body of the vehicle. The vehicle may be moving with respect to the cameras, for creating time-spaced image sequences where a same camera held still captures images depicting different parts of the vehicle. Using an automated process for detecting damages, the same damage region may appear in different images of the same camera and/or in different images of different cameras. For example, what may appear as several damage may actually just be a small scratch or dent. At least some embodiments described herein improve the technical field of image processing, by eliminating redundant instances of a same damage to a body of a vehicle, for generating a set of actual physical damage to the vehicle.

At least some embodiments described herein provide a solution to the aforementioned technical problem, and/or improve upon the aforementioned technical field, by performing multi-level redundancy validation. The multi-level redundancy validation may include one or more of the following: executing spatial correlation between images captured by different images sensors at different heights and/or different angles, executing temporal correlation between consecutive images captured by each image sensor, and validating persistence of each candidate region of damage across a threshold number of consecutive frames.

At least some embodiments described herein provide a solution to the aforementioned technical problem, and/or improve upon the aforementioned technical field, by performing a spatiotemporal correlation between multiple time-spaced image sequences captured by multiple image sensors positioned at multiple different views. Multiple candidate regions of damage are identified for multiple images of the sequences. It is undetermined whether the multiple candidate regions of damage represent different physical regions of damage, or correspond to the same physical region of damage. The spatiotemporal correlation includes a time correlation and a spatial correlation which may be computed using different processing pipelines, optionally in parallel. The time correlation is performed between images (e.g., frames) captured by a same image sensor at different times. The spatial correlation is performed between images (e.g., frames) captured by different image sensors each set at a different view. Redundancy is identified for the candidate regions of damage corresponding to a common physical location of the vehicle denoting a single physical damage region. An indication of the common physical location of the vehicle corresponding to the single physical damage region is provided.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

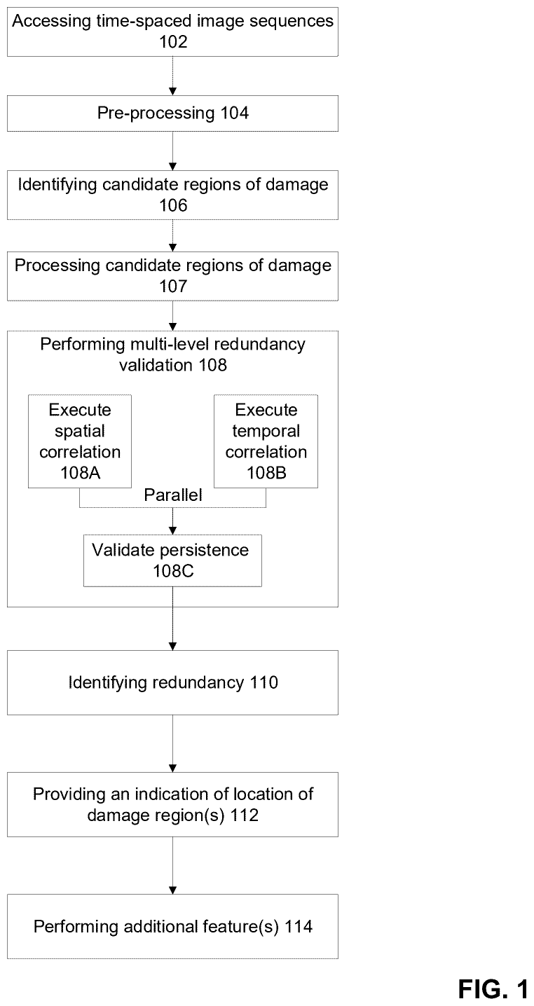

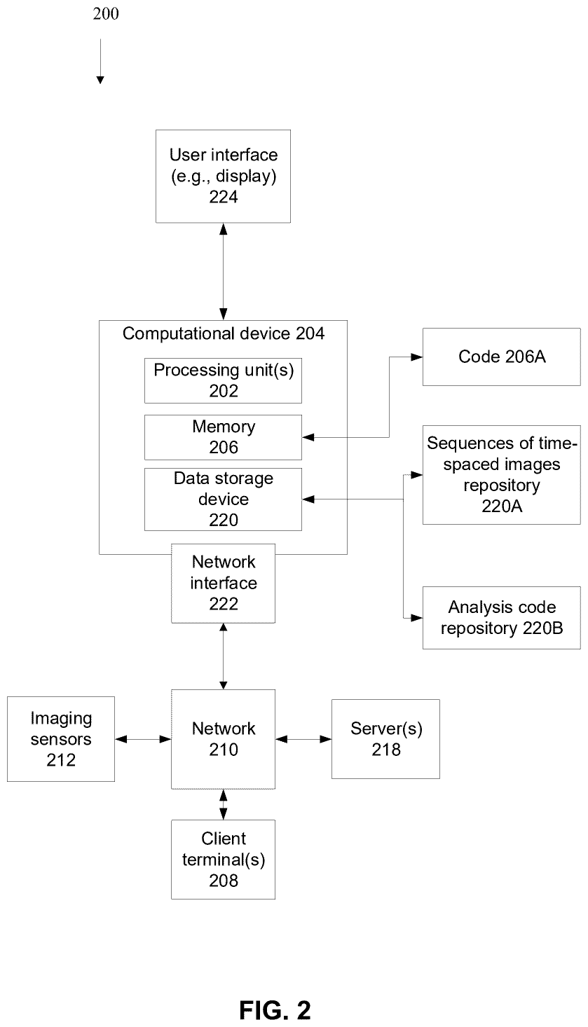

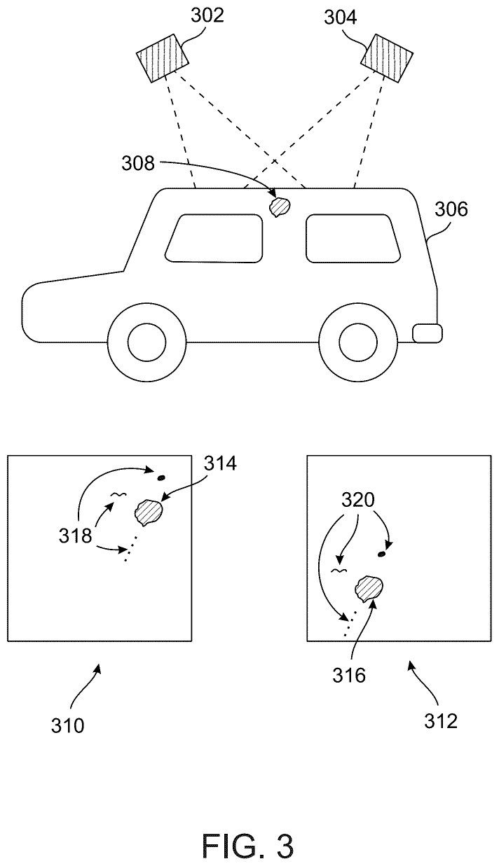

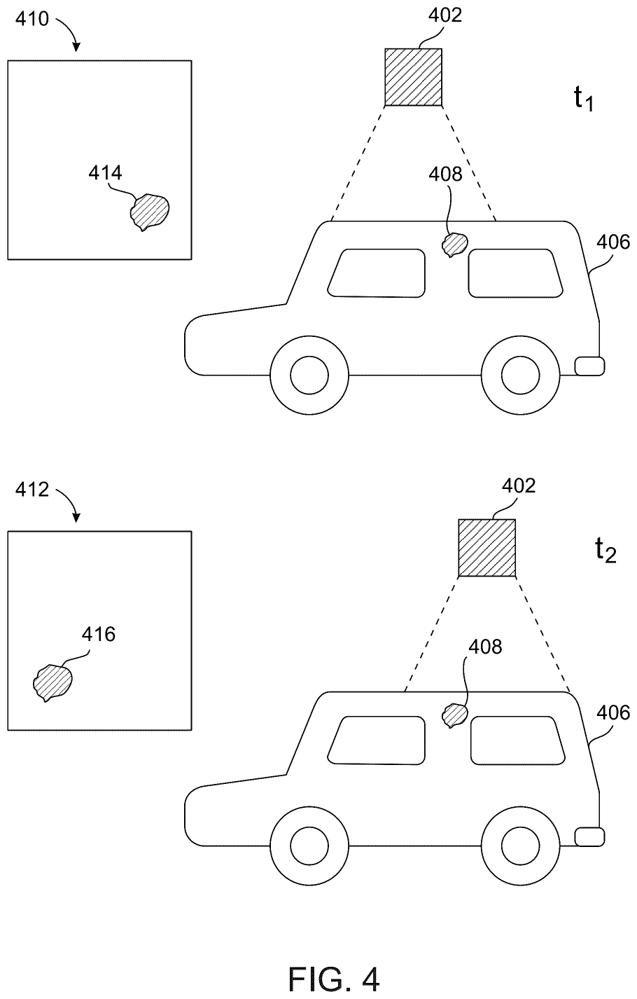

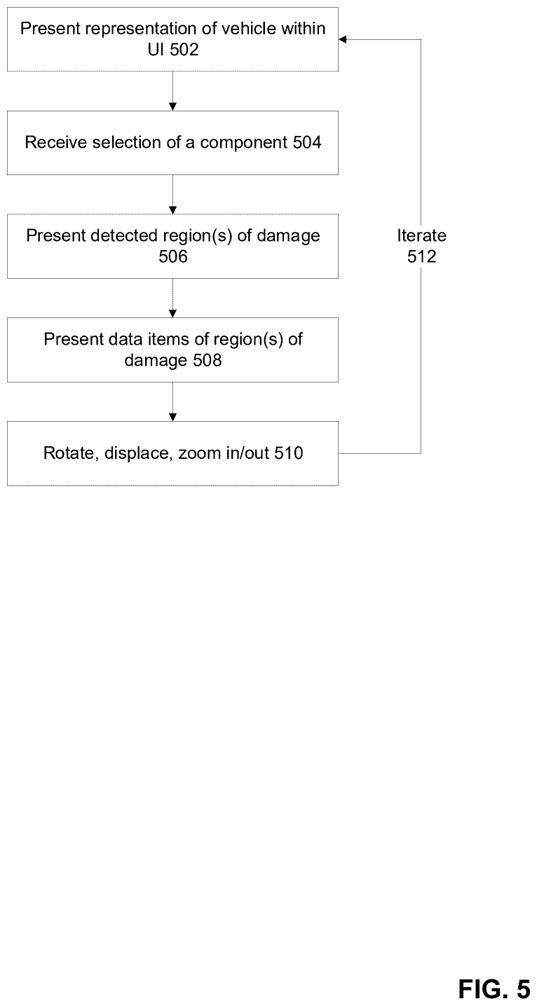

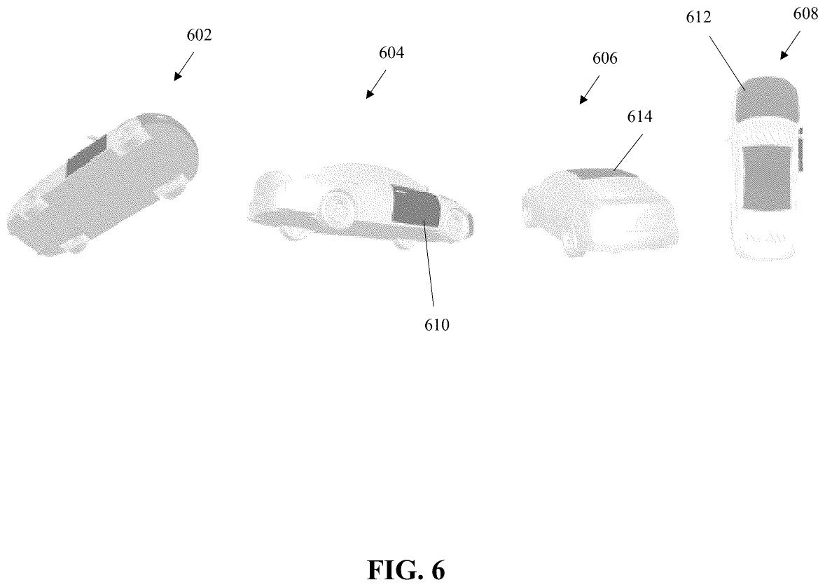

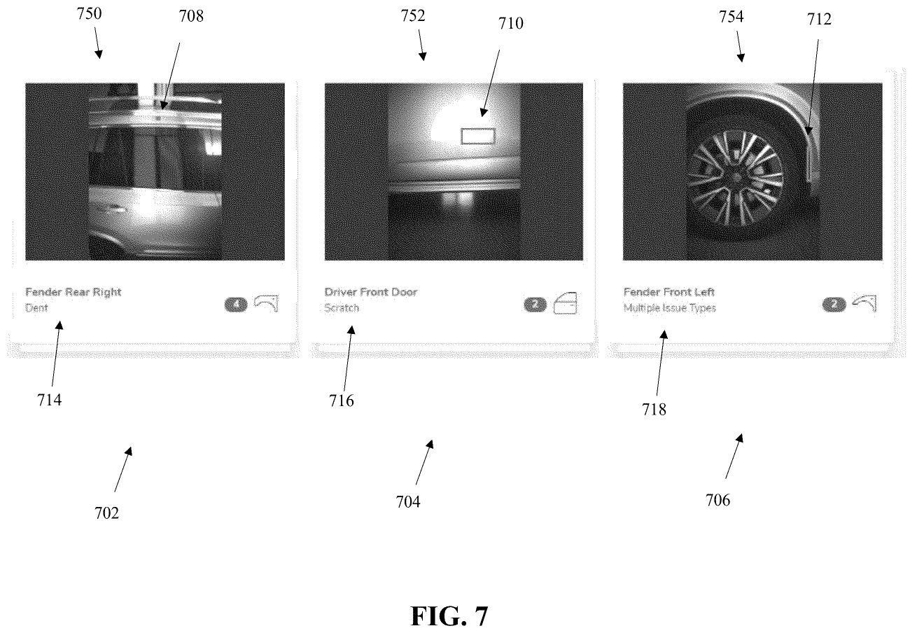

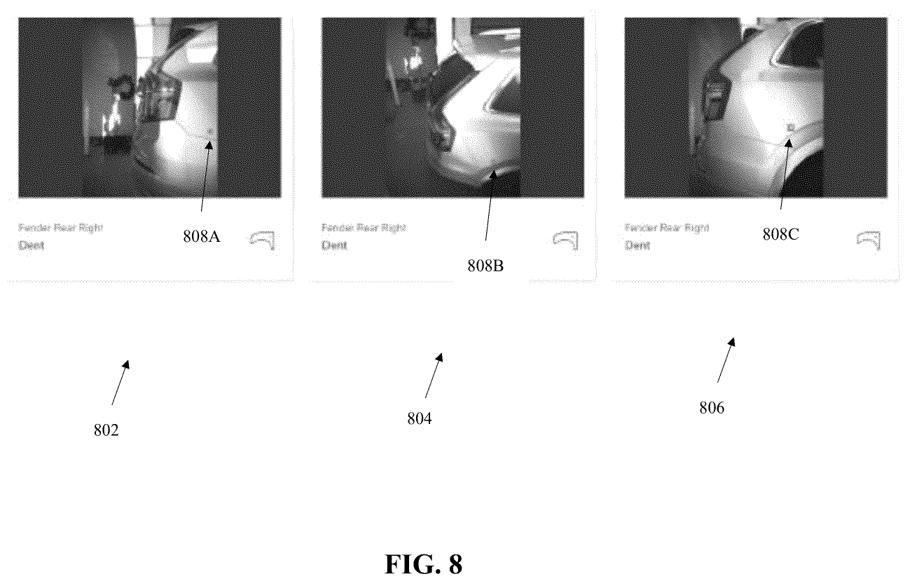

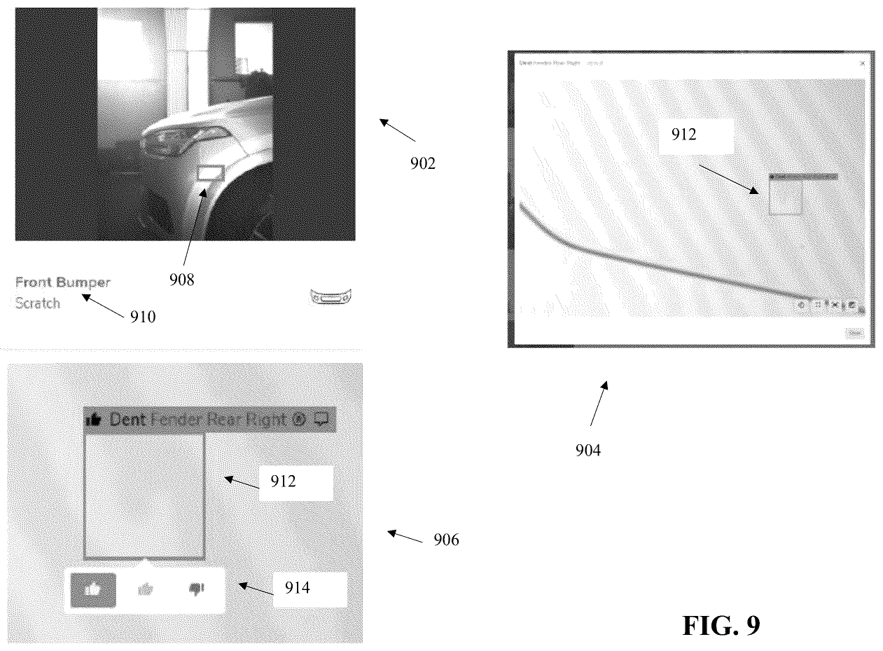

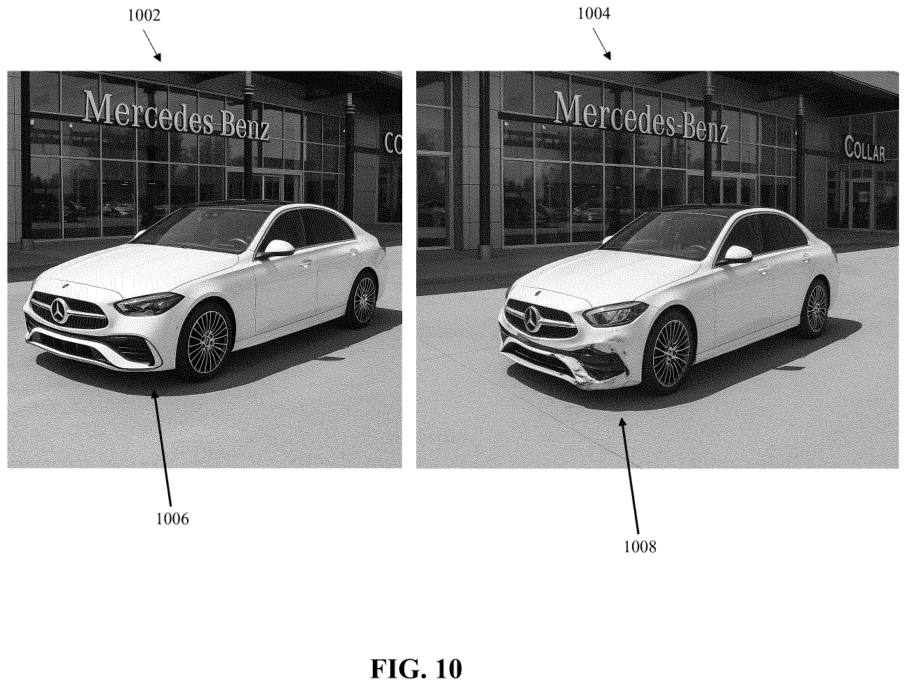

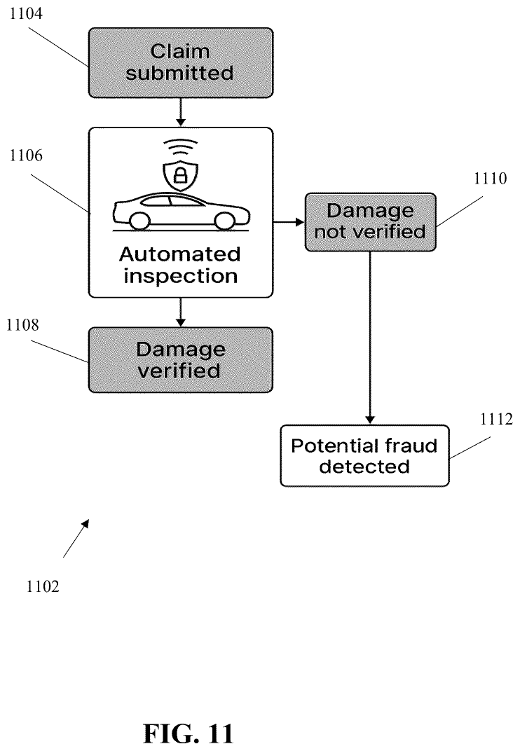

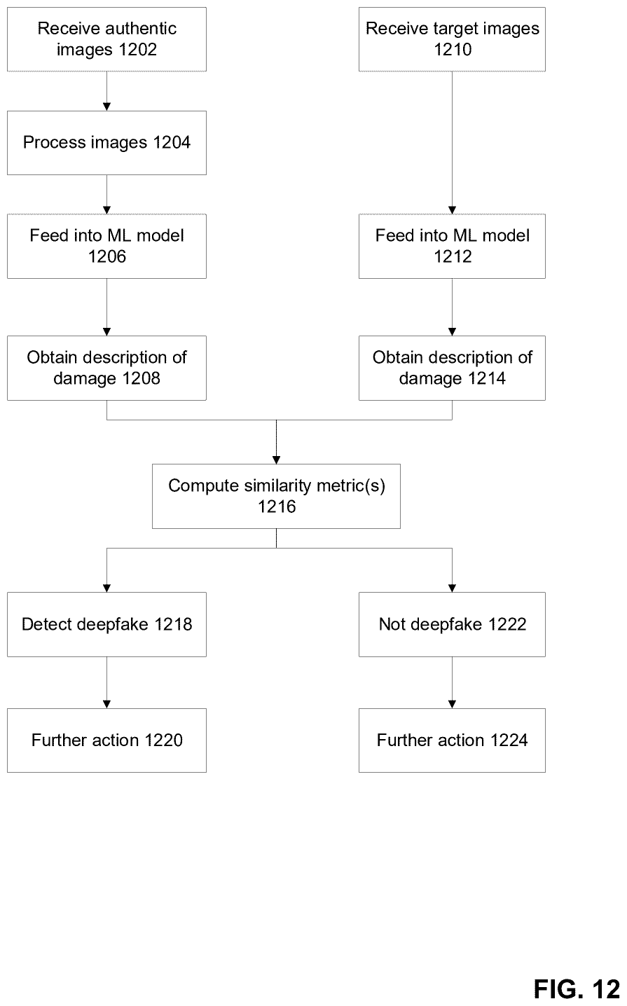

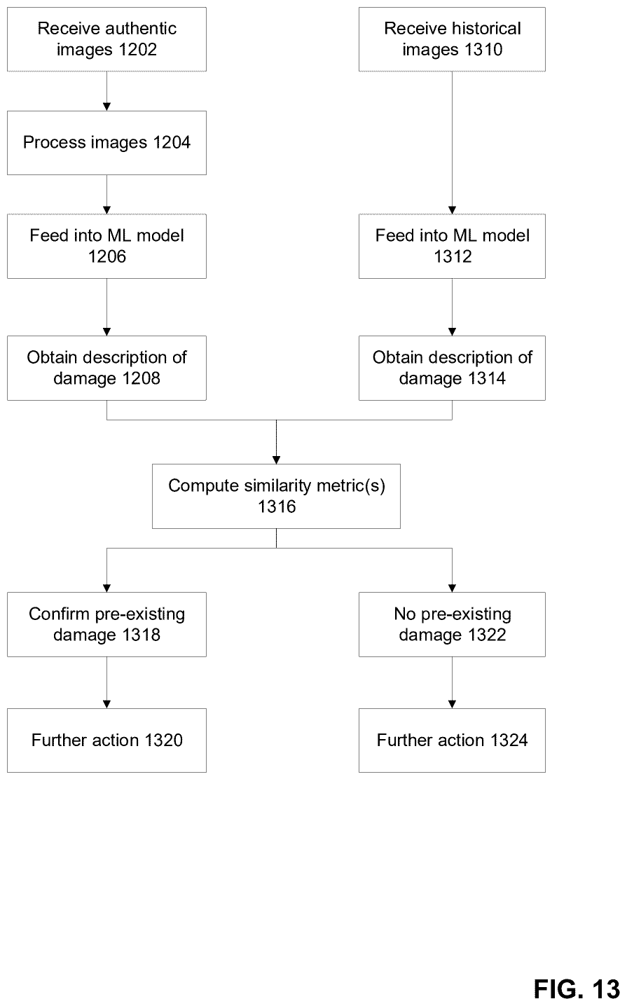

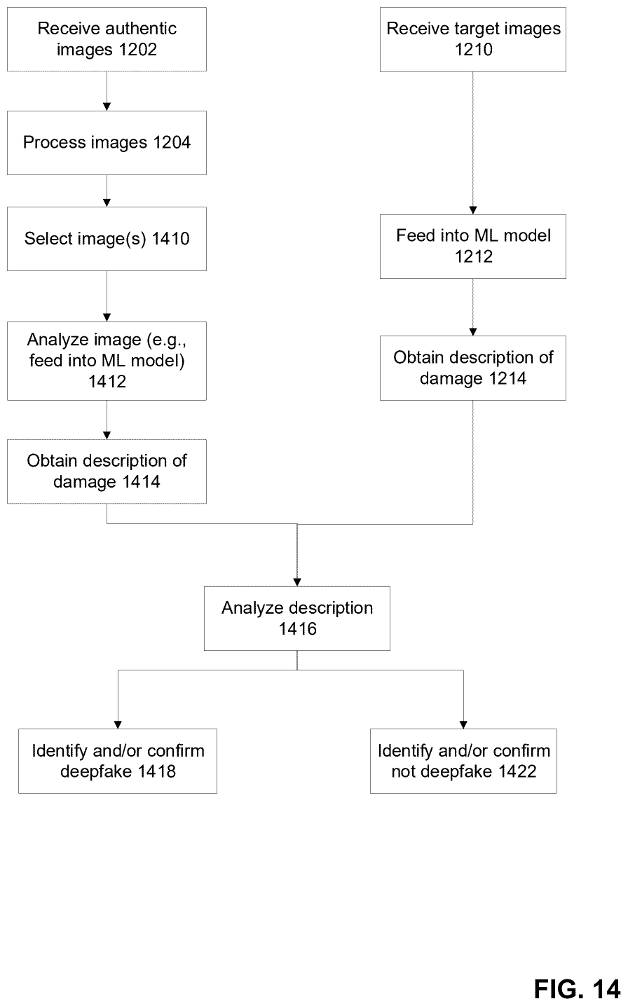

Reference is now made to FIG. 1, which is a flowchart of a method of image processing for detection of damage on a vehicle by identifying redundancy of candidate regions in images, in accordance with some embodiments of the present invention. Reference is also made to FIG. 2, which is a block diagram of components of a system 200 for image processing for detection of damage on a vehicle by identifying redundancy of candidate regions in images, in accordance with some embodiments of the present invention. Reference is also made to FIG. 3, which is a schematic depicting spatial correlation of images of a vehicle, in accordance with some embodiments of the present invention. Reference is also made to FIG. 4, which is a schematic depicting temporal correlation of images of a vehicle, in accordance with some embodiments of the present invention. Reference is also made to FIG. 5, which is a flowchart of a method of operating a user interface, optionally an interactive GUI, presenting identified physical damage regions on a vehicle, in accordance with some embodiments of the present invention. Reference is also made to FIG. 6, which is a schematic of exemplary views of a 3D model of a vehicle presented within a UI, in accordance with some embodiments of the present invention. Reference is also made to FIG. 7, which includes exemplary images of regions of a vehicle with marked detected regions of damage, in accordance with some embodiments of the present invention. Reference is also made to FIG. 8, which includes schematics depicting different views and/or zoom levels of a region of a car with damage, in accordance with some embodiments of the present invention. Reference is also made to FIG. 9, which includes schematic depicting various levels of interaction with an identified region of damage on a vehicle, in accordance with some embodiments of the present invention. Reference is also made to FIG. 10 includes examples of an image 1002 of a vehicle without damage 1006 and a deepfake image 1004 depicting the vehicle with damage 1008 created by adapting the image of the vehicle without damage, in accordance with some embodiments of the present invention. Reference is also made to FIG. 11, which is a flowchart 1102 of an exemplary high-level method for detection of deepfake data depicting damage to a vehicle, in accordance with some embodiments of the present invention. Reference is also made to FIG. 12, which is a flowchart of a method for detection of a deepfake image(s) depicting damage to a vehicle, in accordance with some embodiments of the present invention. Reference is also made to FIG. 13, which is a flowchart of a method for detection of pre-existing damage to a vehicle, in accordance with some embodiments of the present invention. Reference is also made to FIG. 14, which is a flowchart of a method for detection of a deepfake image(s) based on a damage pattern, in accordance with some embodiments of the present invention.

Referring now back to FIG. 2, system 200 may implement the features of the method and/or UI described with reference to FIGS. 1 and/or 3-14, by one or more hardware processors 202 of a computing device 204 executing code instructions stored in a memory (also referred to as a program store) 206.

Computing device 204 may be implemented as, for example, a client terminal, a server, a virtual machine, a virtual server, a computing cloud, a group of interconnected computers, and the like.

Multiple architectures of system 200 based on computing device 204 may be implemented.

In an exemplary centralized implementation, computing device 204 storing code 206A may be implemented as one or more servers (e.g., network server, web server, a computing cloud, a virtual server) that provides services (e.g., one or more of the acts described with reference to FIGS. 1 and 11-14) to one or more servers 218 and/or client terminals 208 over a network 210, for example, providing software as a service (SaaS) to the servers 218 and/or client terminal(s) 208, providing software services accessible using a software interface (e.g., application programming interface (API), software development kit (SDK)), providing an application for local download to the servers 218 and/or client terminal(s) 208, and/or providing functions using a remote access session to the servers 218 and/or client terminal(s) 208, such as through a web browser and/or viewing application. Client terminals 208 may be located in different geographical locations, for example, different vehicle dealerships and/or different garages and/or different vehicle inspection centers. For example, client terminals 208 may sent locally captured time-spaced image sequences of a vehicle captured by multiple image sensors positioned at different views to computing device 204. Computing device 204 reduces redundancy of detected damage, and/or perform other image processing and/or analysis as described herein. One or more outcomes described herein may be provided by computing device 204 to respective client terminals 208, for example, selected images with detected damage, and/or recommendation for fixing the damage, and/or map of detected damage.

In an exemplary localized implementation, code 206A is locally executed by computing device 204. For example, computing device 204 is installed in a local vehicle dealership and connected to locally installed cameras positioned at different views. Time-spaced image sequences of a vehicle captured by the locally installed cameras are locally analyzed and/or processed as described herein. Outcomes may be presented on a display associated with computing device 204.

Code 206A and/or analysis code 220B may include image processing code and/or one or more machine learning models, as described herein. Exemplary architectures of machine learning model(s) may include, for example, one or more of: a detector architecture, a classifier architecture, and/or a pipeline combination of detector(s) and/or classifier(s), for example, statistical classifiers and/or other statistical models, neural networks of various architectures (e.g., convolutional, fully connected, deep, encoder-decoder, recurrent, transformer, graph), support vector machines (SVM), logistic regression, k-nearest neighbor, decision trees, boosting, random forest, a regressor, and/or any other commercial or open source package allowing regression, classification, dimensional reduction, supervised, unsupervised, semi-supervised, and/or reinforcement learning. Machine learning models may be trained using supervised approaches and/or unsupervised approaches.

Image sensors 212 are arranged at different views, optionally with at least some overlap, for capturing images of different parts of the surface of the vehicle. Image sensors 212 may be, for example, standard visible light sensors (e.g., CCD, CMOS sensors, and/or red green blue (RGB) sensor). Computing device 204 receives sequences of time-spaced images captured by multiple image sensors 212 positioned in different views, for example cameras.

Image sensors 212 may transmit captured images to computing device 204, for example, via a direct connected (e.g., local bus and/or cable connection and/or short range wireless connection), and/or via a network 210 and a network interface 222 of computing device 204 (e.g., where sensors are connected via a wireless network, internet of things (IoT) technology and/or are located remotely from the computing device).

Network interface 222 may be implemented as, for example, a wire connection (e.g., physical port), a wireless connection (e.g., antenna), a network interface card, a wireless interface to connect to a wireless network, a physical interface for connecting to a cable for network connectivity, and/or virtual interfaces (e.g., software interface, application programming interface (API), software development kit (SDK), virtual network connection, a virtual interface implemented in software, network communication software providing higher layers of network connectivity).

Memory 206 stores code instructions executable by hardware processor(s) 202. Exemplary memories 206 include a random access memory (RAM), read-only memory (ROM), a storage device, non-volatile memory, magnetic media, semiconductor memory devices, hard drive, removable storage, and optical media (e.g., DVD, CD-ROM). For example, memory 206 may code 206A that execute one or more acts of the method described with reference to FIGS. 1 and/or 3-14.

Computing device 204 may include data storage device 220 for storing data, for example, sequences of time-spaced image repository 220A for storing sequences of time-spaced images captured by imaging sensors 212, and/or analysis code repository 220B which may store code (e.g., set of rules, ML model) for generating recommendations for fixing components according to a pattern of detected damage. Data storage device 220 may be implemented as, for example, a memory, a local hard-drive, a removable storage unit, an optical disk, a storage device, a virtual memory and/or as a remote server 218 and/or computing cloud (e.g., accessed over network 210).

Computing device 204 and/or client terminal(s) 208 include and/or are in communication with one or more physical user interfaces 224 that include a mechanism for inputting data and/or for viewing data, for example, a display for presenting sample images with detected damage regions and/or for entering a set of rules for recommendations on how to fix patterns of different types of damage. Exemplary user interfaces 224 include, for example, one or more of, a touchscreen, a display, a keyboard, a mouse, and voice activated software using speakers and microphone.

Referring now back to FIG. 1, at 102, multiple time-spaced image sequences depicting one or more regions of a vehicle, are accessed. For example, obtained from image sensors (e.g., cameras), from a data storage device storing images captured by the image sensor, and/or obtained over a network connection (e.g., when a server and/or cloud based service performs the analysis of image captured by image sensors at multiple different geographical locations).

The time-spaced image sequences are captured by multiple image sensors positioned at a multiple different views (e.g., poses), for example, at different locations and/or different poses relative to the car. For example, cameras may be installed along an arch and/or frame that surrounds at least a portion of the car (e.g., sides and top).

Each time-spaced image sequence includes multiple images captured by an image sensor over a time interval, where each image is captured at a different time. For example, frames of a video captured at a certain frame rate, for example, one frame every second, one frame every three seconds, and the like.

The image sensors and vehicle may move relative to one another. For example, the vehicle may be moving relative to the image sensors, for example, slowly driven and/or pulled through a frame on which the image sensors are installed. In another example, the vehicle remains still, while the frame on which the image sensors are installed in moved across the body of the vehicle. In yet another example, the pose of the image sensors is changed, for example, the image sensors are swept across the surface of the body of the vehicle.

The individual images of the time-spaced image sequences may vary in the region(s) of the vehicle depicted, for example, a subsequent image may depict a lateral displacement of the region of the body of the vehicle depicted in a preceding image. The variation of the region(s) of the vehicle depicted in the image may be a function of relative motion between the vehicle and image sensors, and/or a function of the frame rate at which the images are captured.

Images of the time spaced-image sequence may be synchronized to be captured at substantially the same time. For example, two cameras may be set to capture overlapping images of the body vehicle at substantially the same time.

The rate of relative motion between the image sensors and/or the frame rate may be selected to obtain a target overlap between images of the time-spaced image sequences, for example, about 10-30%, or 30-60%, or 5-25%, or 25-50%, or 50-75%, or other values. The overlap may be selected, for example, in view of approaches for reducing redundancy described herein.

The time-spaced image sequences may be selected to have a resolution and/or zoom level for enabling identifying redundancy with a target accuracy, for example, a dent of about a 2 centimeter diameter on the vehicle may represent about 1%, or 5%, or 10% of the area of the image, or other values such as according to approaches used for reducing redundancy.

The regions depicted in the time-spaced image sequence may be of a body of a vehicle, optionally excluding the bottom of the car. Examples of regions depicted in the time-spaced image sequences include: front bumper, rear bumper, hood, doors, grill, roof, sunroof, windows, front wind shield, read wind shield, and trunk.

At 104, one or more pre-processing approaches may be implemented. The pre-processing approaches may be implemented on the raw time-spaced image sequences.

Optionally, each of the time-spaced images of each sequence may be classified into a classification category. The classification category may correspond to a physical component of the vehicle, optionally according to regions which may be replaceable and/or fixable. Examples of classification categories include: front bumper, rear bumper, hood, doors, grill, roof, sunroof, windows, front wind shield, read wind shield, and trunk. Alternatively or additionally, the classification categories may include sub-regions of components. The sub-regions may be selected according to considerations for a recommendation of whether the component should be fixed or replaced. For example, a driver's side door may be divided into 4 quadrants. Damage to 2 or more quadrants may generate a recommendation to replace the door, rather than fixing damage to the 2 or more quadrants. The time-spaced images may be clustered into multiple clusters, where each cluster corresponds to one of the classification categories. One or more features described herein, such as identification of damage, performing spatiotemporal correlation and/or multi-level redundancy validation, identification of redundancy, detection of damage, and/or other features described herein, may be performed per cluster. Analyzing each cluster may improve the recommendation for whether the physical component corresponding to the cluster should be fixed or replaced.

The classification may be performed, for example, by a machine learning model (e.g., detector, classifier) training on a training dataset of image of different physical components labelled with a ground truth of the physical component, and/or by image processing code that analyses features of the image to determine the physical component (e.g., shape outline of the physical component, pattern of structured light indicating curvature of the surface of the physical component, and/or key features such as door handle or designs.

Alternatively or additionally, one or more common physical location are segmented from the time-spaced image sequences. The common physical location may be the physical component, or part thereof, of each cluster. One or more features described herein, such as identification of damage, performing spatiotemporal correlation and/or multi-level redundancy validation, identification of redundancy, detection of damage, and/or other features described herein, may be performed for the segmented portion of the image, rather than for the image as a whole. Analyzing the segment may improve performance (e.g., accuracy) of the analysis, by analyzing the physical component while excluding other portions of the vehicle which are not related to the common physical component. For example, the driver side (front) door is being analyzed to determine the extent of damage, which is unrelated to damage to the rear passenger (back) door. The segment may include the driver side door, while excluding the rear passenger door depicted in an image.

Alternatively or additionally, for time-spaced image sequences captured during motion between the vehicle and image sensors, filtered time-spaced image sequences are computed by removing background from the time-spaced image sequences that doesn't move. The background for removal may be identified as regions of the time-spaced images that doesn't move according to a predicted motion between the vehicle and the image sensors. For example, when the vehicle is moving relative to the image sensors at about 10 centimeters a second, background that does not more at all, or moves much more slowly than about 10 centimeters a second, and/or background that moves much faster than about 10 centimeters a second may be removed. Such background is assumed to not be part of the vehicle body. One or more features described herein, such as identification of damage, performing spatiotemporal correlation and/or multi-level redundancy validation, identification of redundancy, detection of damage, and/or other features described herein, may be performed on the filtered time-spaced image sequences.

At 106, candidate regions of damage are identified in the time-spaced image sequences. One or more candidate regions of damage may be identified per image of the time-spaced image sequences.

The candidate regions of damage may be identified by feeding each image into a machine learning model (e.g., detector) trained on a training dataset of sample images of region(s) of a body of a sample vehicle labelled with ground truth indicating candidate regions of damage and optionally including images without damage. The machine learning model may generate the candidate region of damage as an outcome, for example, an outline encompassing the damage (e.g., bounding box), a tag indicating presence of damage in the image, markings (e.g., overlay) of the identified damage, and the like. In another example, the candidate regions of damage may be identified by image processing code, for example, by shining structured light on the body of the vehicle, and extracting features from the image to identify disruption of the a pattern of the structured light on the body of the vehicle. The disruption of the patter of the structured light may indicate an aberration on the smooth surface of the body, such as scratch and/or dent, likely being damage.

At 107, the identified candidate regions of damage and/or images depicting the identified candidate regions of damage, may be used for pre-processing and/or computation of values.

Optionally, a confidence score is computed for each candidate region of damage. The confidence score may be computed according to one or more of, optionally a combination of the following (e.g., sub-scores): overlap, partial visibility, errors in transformation, angle consistency, and damage characteristics. The sub-scores may be weighted and/or transformed using a function to a probability that is used to determine whether a pair of images depicts the same damage region or not, i.e., redundancy as detailed herein. A subset of the candidate regions of damage having confidence scores above a confidence threshold. The multi-level redundancy validation may be performed for the subset of candidate regions of damage. Using the confidence score may help ensure that high-confidence, redundant damage regions are selected for multi-level redundancy validation.

Additional exemplary details regarding the overlap used to compute the confidence score are now provided. The confidence score may be computed for a first candidate region of damage depicted in a first image according to overlap with a second candidate region(s) of damage depicted in a second image(s). The higher the amount of overlap between the first and second candidate regions of damage, the higher the likelihood that the first and second candidate regions of damage represent the same region of damage. Overlap may refer, for example, to one or more of: similarity between size of the first candidate region of the first image and the second candidate region of the second image, ratio of the first candidate region and the second candidate region, and a distance between a center of the first candidate region and the second candidate region. The first image may be registered to the second image, or the second image may be registered to the first image. Registration between the first image and the second image(s) may be computed by mapping the first image and the second image(s) to a common coordinate system. The overlap between the first candidate region of damage and the second candidate region(s) of damage may be computed according to the common coordinate system.

The confidence score may take into account partial visibility of the candidate region and/or errors in transformation between a first candidate region of damage depicted in a first image to a second candidate region of damage depicted in a second image, where the transformation may be computed using approaches described herein. The confidence score may be reduced in cases of partial visibility and/or errors in transformation. The confidence score may be adjusted according to the amount of partial visibility and/or amount of error in the transformation. Partial visibility may occur when a portion of the damage is visible in the image.

Additional exemplary details regarding the angle consistency used to compute the confidence score are now provided. A first pose of an image sensor that captured a first image depicting the respective candidate region of damage, may be obtained and/or computed. The pose may be known, such as measured and/or set and/or computed in advance, for example, where the pose of the image sensor is fixed with respect to a defined location on the vehicle depicted in the captured image. In another example, the pose may be computed, for example, by identifying one or more known markers (e.g., as described herein) in the image, and computing the pose of the image sensor according to the appearance of the marker(s) in the image. A second pose of the image sensor that captured a second image depicting the respective candidate region of damage may be obtained and/or computed. A similarity between the first pose and the second pose is computed. A high similarity indicates high probability that the same image sensor was used to capture the first image and the second image, indicating a high confidence.

Damage characteristics used to compute the confidence score may indicate likelihood of actual damage versus artifacts for the respective candidate region of damage. Damage characteristics may be computed by analyzing at least one image depicting the respective candidate region of damage. The analysis may be performed by feeding the image into a machine learning model (e.g., neural network) which may be trained on images depicting actual damage and images depicting artifacts, labelled accordingly with a ground truth. In another example, the analysis may be performed using other approaches, such a feature extraction and analysis of the extracted features to identify patterns indicative of actual damage versus artifacts.

Optionally, images captured by different images sensors and depicting candidate regions of damage are analyzed to identify lightening conditions. Each image may be analyzed to identify and/or measure the lighting conditions depicted therein, for example, poor lighting, spot light, bright light, shadow, reflections, and the like. Differences in lighting conditions may arise for different vehicles and/or for different images of the same vehicle, due to, for example, color of the vehicle, dust on the vehicle, wax applied to the vehicle, lighting from the sun, shadows due to objects in the field of view, reflections off a window of the vehicle, and the like. The lighting conditions may be analyzed, for example, by feeding into a machine learning model (e.g., neural network, classifier, regression model) which may be trained on images depicting different lighting conditions, labelled accordingly with a ground truth. In another example, lighting conditions may be analyzed, for example, by extracting features from the image and/or by analyzing patterns of pixel intensities in the image. The lighting conditions may be taken into account when computing one or more values described herein and/or executing one or more processes described herein, for increasing likelihood of correctly removing redundancies.

Optionally, a lighting intensity score is computed, for example, by the machine learning model and/or other approaches. The lighting intensity score may be associated with the confidence score computed for each candidate region of damage. The lighting intensity score may be used to optimize for maximum detection rate (e.g., recall) by setting optimal threshold for different lighting intensities. For example, using a look-up table that maps each intensity range to a threshold and/or by training a boosting algorithm to output singe confidence based on the two parameters (i.e., confidence, lighting intensity score).

Optionally, an overlap threshold indicating amount of overlap between a first image captured by a first image sensor depicting a first candidate region of damage, and a second image captured by a second image sensor depicting a second candidate region of damage, is dynamically adjusted according to the identified lighting conditions. The overlap threshold may be used for computing the confidence score, as described herein. The overlap threshold may be dynamically adjusted for accounting for, for example, shadow, reflection, and/or other lighting condition inconsistencies described herein, for reducing probability of misidentifying redundant damage regions.

At 108, a multi-level redundancy validation is performed based on the time-spaced image sequences obtained from the image sensors at different heights and/or different angles relative to the vehicle.

The multi-level redundancy validation may be performed to remove redundantly detected candidate regions of damage, for obtaining unique regions of damage to the vehicle, representing a single physical damage region.

The multi-level redundancy validation may be performed by separately executing spatial correlation between images captured by different images sensors at different heights and/or different angles 108A and executing temporal correlation between consecutive images captured by each image sensor 108B, for example, using different processing pipelines described herein.

An exemplary approach for executing spatial correlation 108A is described for example, with reference to FIG. 3.

An exemplary approach for executing temporal correlation 108B is described for example, with reference to FIG. 4.

The temporal correlation computed in 108B may be combined with the spatial correlation in 108A to obtain the spatiotemporal correlation described herein.

The multi-level redundancy validation may include validating persistence of each candidate region of damage across a threshold number of consecutive frames 108C.

Persistence of each candidate region of damage may be validated by tracking each respective candidate region of damage across multiple consecutive frames. The candidate region may be tracked over multiple consecutive frames to help ensure that it is the same candidate region that is being tracked, rather than different candidate regions. The candidate region may be tracked over multiple consecutive frames obtained from the same image sensor and/or obtained from different image sensors. The candidate region may be temporally and/or spatially tracked over multiple consecutive frames, by following the same candidate region when the candidate region remains substantially the same location over the multiple consecutive frames (e.g., when there is no relative movement between the vehicle and image sensor), or when the candidate regions appears to be displaced to different locations over the multiple consecutive frames (e.g., when there is relative movement between the vehicle and image sensor). The candidate region may be tracked over multiple consecutive frames, for example, based on optical flow approaches, feature extraction, mappings of features, registration of images, and the like.

A number of consecutive frames in which each respective candidate region is detected during the tracking, representing the same candidate region, is determined. The respective candidate region of damage may be designated as an actual region of damage when the number of frames in which the respective candidate region of damage appears is greater than a selected threshold number of consecutive frames. The threshold may be selected, for example, according to lighting conditions, location of damage on the vehicle, type of image sensor, and the like. The threshold may be selected according to desired probability of correctly determining the actual region of damage. Alternatively, the respective candidate region of damage may be designated as non-actual damage, for example, transient visual artifacts, when the number of frames in which the respective candidate region of damage appears is less than the threshold number of consecutive frames. For example, a shadow appearing on the car may appear to be a candidate region of damage. However, in subsequent frames, when the shadow disappears or appears to move to a different location on the car, i.e., is non-persistent, the candidate region of damage may be determined to be a visual artifact.

Candidate regions of damage which are determined to represent actual regions of damage are further processed to identify redundancy, as described herein.

An additional exemplary approach for executing spatial correlation is now described. The exemplary approach may be used in addition to, and/or as an alternative to, other approaches for executing spatial correlation described herein. Each of the images captured by different images sensors and depicting candidate regions of damage may be analyzed identify at least one predefined marker. The predefined marker may be a spatial visual marker visible in the field of view (FOV). The predefined marker may be a known physical features of the vehicle, for example, a door, a window, a bumper, a wheel, a door handle, gas tank cover, and the like. The predefined marker may be identified, for example, by feeding the image into a machine learning model trained to detect and/or segment the predefined marker (e.g., neural network, detector), by identifying known features of the marker (e.g., edge detection, intensity pattern, line patterns), and the like. The predefined marker(s) (or features extracted from the predefined marker(s) detected in a first image captured by a first image sensor depicting a first candidate region of damage, may be matched with at least one predefined marker detected in a second image captured by a second image sensor depicting a second candidate region of damage. The matching may be done in two dimensions. The matching may be done, for example, by registering the first image to the second image and registering the first marker to the second marker, by transforming both images to a common plane, and the like. The matching of the markers between the two images enables computing a mapping between the two candidate regions of damage of the two images. A three dimensional mapping may be computed between a first pose of the first sensor and a second pose of the second sensor. The 3D mapping may be computed according to the two dimensional location of the candidate region of damage and intrinsic information of the different image sensors. The 3D mapping may be used to identify redundancy by validating that the first candidate region of damage captured by the first image sensor is the same as the second candidate region of damage captured by the second image second.

Additional exemplary details to geometrically match damage regions using 3D or pseudo 3D, to identify redundancies, are now described. The markers may be depicted in each frame and matched in 2D. Using intrinsic information regarding the sensors together with the 2D coordinates of the markers, mathematical optimization that approximates the sensor's position relative to another sensor in 3D may be computed. The result of the computation may be used to compute epipolar lines that match points with lines on the corresponding sensor. This approach may be used for geometrical matching of candidate damage regions through 3D or pseudo 3D.

Alternatively, the spatiotemporal correlation and/or multi-level redundancy validation may be performed together (e.g., simultaneously and/or in a common processing pipeline).

The spatiotemporal correlation and/or multi-level redundancy validation may be performed for each pair of images. Multiple pairs of images may be defined, where a pair may include a first image and a second image from a same sequence, or from different sequences. The pair of images may be of a common segmented physical location. The pair may be of images of a common cluster. The segmentation and/or clustering may reduce the number of pairs of images to the most relevant pairs of images that most likely correspond to a same physical location of the vehicle. Reducing the number of image pairs improves computational performance of the processor and/or computing device, for example, by reducing processing time, reducing utilization of processing resources, reducing utilization of memory, and the like.

The spatiotemporal correlation and/or multi-level redundancy validation may be performed by correlating between different images of different sequences captured by different image sensors oriented at different views, optionally at synchronized points in time, for example, correlating between different images of different sequences captured at substantially the same time. The different images of different image sensors at different views may overlap at the common physical location of the vehicle captured at substantially the same time. The aforementioned may be an example of spatial correlation 108A for images at different poses.

Alternatively or additionally, the spatiotemporal correlation and/or multi-level redundancy validation may be performed by correlating between images of a same sequence captured by a same image sensor in a fixed pose, where the images are captured at different times. The vehicle and image sensor are moving relative to one another. The aforementioned may be an example of temporal correlation 108B.

Alternatively or additionally, the spatiotemporal correlation and/or multi-level redundancy validation may be performed by correlating between different images of different sequences captured by different image sensors at different views, captured at different points in time. The different images of different image sensors at different views may overlap at the common physical location of the vehicle. The aforementioned may be an example of a combination of spatial correlation 108A and temporal correlation 108B.

Optionally, the spatiotemporal correlation and/or multi-level redundancy validation is performed according to matching features detected on a first image and a second image of a pair. Features are detected in the first image and the second image of the pair. The features may be detected using image processing approaches, for example, scale-invariant feature transform (SIFT), Speeded-Up Robust Feature (SURF), Orientated FAST and Robust BRIEF (ORB), and the like. The features detected in the first image may be matched to features detected in the second image, for example, using a brute-force matcher, Fast Library for Approximate Nearest Neighbors (FLANN) matcher, and the like.

The matched features may be within the respective candidate regions of damage of the first image and second image, excluding features external to the candidate regions of damage. Alternatively, the matched features include both the features within the candidate regions of damage and the features external to the candidate regions of damage.

An exemplary not necessarily limiting approaches for spatial correlation 108A is now described. A transformation between the first image captured by a first image sensor oriented at a first view and the second image captured by a second image sensor oriented at a second view different than the first pose, is computed. The transformation may be computed according to the identified features of the first image that match to the corresponding identified features of the second image. The transformation may be computed, for example, as a transformation matrix. The first image and the second image each depict a respective candidate region of damage, referred to herein as a first candidate region of damage (for the first image) and a second candidate region of damage (for the second image). The transformation may be computed as a transformation matrix. The transformation may be computed between the candidate region of the first image and the candidate region of the second image, according to features of the first candidate region of the first image that match to features of the second candidate region of the second image. Features external to the first image and/or the second image may be excluded from the computation of the transformation. The transformation may be applied to the first image to generate a transformed first image depicting a transformed first candidate region of damage. A correlation may be computed between the second candidate region of damage and the transformed first candidate region of damage. Redundancy of the first candidate region of damage and the second candidate region of damage when the correlation is above a threshold. The threshold may indicate, for example, an amount of overlap of the second candidate region of damage and the transformed first candidate region of damage, at the common physical location. In another example, the threshold may indicate a selected likelihood (e.g., probability) corresponding to a value of the correlation. For example, a correlation of 0.85 may correspond to a probability of 85% of matching.

Redundancy refers to the first candidate region of damage of the first image corresponding to a same physical location on the vehicle as the second candidate region of damage of the second image. Or in other words, that the same physical location on the vehicle is depicted in both the first image and the second image as the first and second candidate regions of damage.

An exemplary not necessarily limiting approaches for temporal correlation 108B is now described. The temporal correlation may be computed for a first image and a second image captured by a same image sensor at different times. The vehicle and image sensor may be moving relative to each other, such that the first image and the second image depict different regions of the vehicle, with possible overlap in candidate regions of damage. The relative movement may occur by the vehicle moving relative to the image sensor and/or the at least one image sensor moving relative to the vehicle.

A predicted candidate region of damage may be computed. The predicted candidate region of damage may include a location of where the first candidate region of damage depicted in the first image is predicted to be located in the second image. The prediction may be computed according to a time difference between capture of the first image and the second image, and/or according to a relative movement between the vehicle and the image sensor. The prediction may be computed, for example, by applying an image motion approach, for example, applying optical flow to features of the image for displacement of the image according to the relative movement occurring between the time of capture of the first and second images, and the like. For example, when the first image and the second image are captured about one second apart, during which time the vehicle moved about 10 centimeters past the image sensor, the first image and/or the first candidate region of damage is displaced an amount of pixels corresponding to 10 centimeters. A correlation between the predicted candidate region of damage and the second candidate region of damage may be computed. Redundancy may be identified when a correlation between the first candidate region of damage and the second candidate region is above a threshold. The threshold may indicate, for example, an amount of overlap of the second candidate region of damage and the transformed first candidate region of damage, at the common physical location. In another example, the threshold may indicate a selected likelihood (e.g., probability) corresponding to a value of the correlation. For example, a correlation of 0.85 may correspond to a probability of 85% of matching.

At 110, redundancy in the candidate regions of damage corresponding to a common physical location of the vehicle denoting a single physical damage region on the vehicle, is identified. Redundancy may be identified for a pair of images when the first candidate region of damage of the first image likely corresponds to the same physical region of the vehicle as the second candidate region of damage of the second image of the pair of images.

The identification of redundancy may be performed for identifying one or more single physical damage regions within a common physical component of the vehicle. For example, two damage regions on a driver side door, one damage region may be towards the left (front of the vehicle), and a second damage region may be towards the right (back of the vehicle).

The identified redundancy may be removed and/or ignored to obtain the single physical damage region. The identification of redundancy may help improve recommendations for fixing of the damage, by avoiding erroneous recommendations for example, based on erroneous multiple damage regions detected in multiple images when only a single damage region is present. In such a case, the erroneous recommendation to replace an entire part due to extensive damage is avoided, while a correct recommendation to perform a spot fix of a small region of damage may be provided.

Optionally, redundancy is identified by analyzing each image depicting a candidate region of damage to identify a 3-point correlation. The 3-point correlation includes a timestamp associated with the image indicating the time when the image was captured, a pose of an image sensor capturing the image (obtained and/or computed as described herein), and alignment of the image which may be performed by transforming the image as described herein. The image depicting the candidate region of damage may be designated as unique when the 3-point correlation associated with the image is non-correlated with another 3-point correlation of another image depicting the candidate region of damage. The image depicting the candidate region of damage may be designated as redundant when the 3-point correlation associated with the image is correlated with another 3-point correlation of another image depicting the candidate region of damage. The correlation between each element of the 3-point correlation may be within a defined error range, to account for variations, for example, in time between capturing of the different image, slight variations in pose of the image sensor, and/or variations in computation of the transformation.

Alternatively or additionally, redundancy identification is performed for the detected candidate regions of damage which are matched to one another using approaches described herein. Each detection may be treated as a “cluster” of occurrences of the same region of damage from different sources. A decision of whether each cluster represents an actual damage or a false detection may be executed. For example, by using a voting approach where it is desired to have at least a predefined number of appearances of the candidate region of damage in each cluster with a confidence above a threshold. In another example, one or multiple voting rules may be used. For example, higher confidence requires less occurrences in the cluster, and a lower threshold required more occurrences. Each combination of vehicle component and label may be analyzed, such as by using a lookup table for decision making, which may optimize the potential recall and precision. It is to be understood that the aforementioned process may be implemented using other approaches, for example, boosted models.

The redundancy may be identified according to the computed spatiotemporal correlation and/or multi-level redundancy validation between time-spaced images of the sequences. Candidate regions of damage that are spatiotemporally correlated with other image in the same time-spaced time sequence and/or in another time-spaced image sequence may be flagged as redundant. The redundant candidate regions may be removed and/or ignored. The candidate regions which are unflagged and/or are not spatiotemporally correlated with other candidate regions represent non-redundant region of damage.

A baseline region represent one candidate region of damage in one of the time-spaced images corresponding to the physical location of the vehicle may be selected. Candidate regions of damage in other time-spaced images that correlate to the same physical location of the vehicle as the baseline region of damage may be ignored. The correlation may be spatiotemporal, for example, overlap in candidate regions of damage of at least a predefined threshold. Candidate regions of damage in other time-spaced images that do not correlate to the same physical location of the vehicle as the base line region of damage and are located in another physical location of the vehicle, may be labelled as actual regions of damage.

At 112, an indication of the common physical location(s) of the vehicle corresponding to the single physical damage region(s) is provided. The common physical location(s) of the vehicle corresponding to the single physical damage region(s) represent the set of actual damage regions (i.e., one or more), after redundancy depicted in the images is accounted for, for example, by being removed and/or ignored.

The indication may be, for example, presented on a display optionally with a user interface (e.g., graphical user interface), used to generate a report for the vehicle, stored on a data storage device, fed into another automated process, and/or forwarded to another device.

At 114, one or more additional features may be performed.

Optionally, a recommendation for fixing the common physical component is computed and/or provided. The recommendation may include, for example, whether to fix the existing damage or replace the damaged physical component. For example, in some instances where there are multiple different physical damage regions on the component, such as on a door, the component of the door may be replaced rather than locally fixing the damage in the multiple different physical damage regions, for example, due to difference in costs of multiple fixes as opposed to a replacement, and/or inability to achieve aesthetics of fixing in comparison to replacement.

The recommendation may be generated by analyzing the single physical damage region(s) within the common physical component of the vehicle. The analysis may be performed by classifying each of the single physical damage regions into a damage category, which may indicate type of damage and/or extend of damage, for example, superficial scratch, deep scratch, dent, broken surface, and the like. The classification may be performed by a machine learning model trained on a training dataset of images depicting different physical damage regions labelled with ground truth labels selected from defined damage categories. The analysis may be based on a combination of one or more of: number of single physical damage regions, pattern of distribution of the single physical damage regions, and/or damage categories. The recommendation may be generated, for example, based on a set of rules and/or using a machine learning model trained on a training dataset of different combinations of number of damage regions, pattern of distribution, and/or damage categories, labelled with a ground truth label indicating the recommendation.

Alternatively or additionally, a map of the physical components of the vehicle marked with respective locations of each of the single physical damage regions may be generated. The map may be generated based on images depicting multiple different regions of the vehicle. The map may be presented within an interactive GUI, where a user may click on an indication of each physical damage region to obtain additional details, for example, recommendation, type of damage, estimated cost to fix, and the like.

Alternatively or additionally, a user interface, optionally an interactive GUI, may be generated and/or presented on a display.

Referring now back to FIG. 3, the spatial correlation depicted with reference to FIG. 3 may be implemented, for example, as described with reference to 108A of FIG. 1. A first image sensor 302 and a second image sensor 304 set at different views relative to a vehicle 306 are shown. Vehicle 306 has a region of damage 308 on its roof. Image 310 is captured by first image sensor 302. Image 312 is captured by second image sensor 304. Images 310 and 312 may be captured at substantially the same time, for example, when vehicle 306 is moving relative to image sensors 302 and 304. Damage 308 is depicted as damage 314 in image 310, and as damage 316 in image 312. However, based upon inspection of images 310 and 312, it is unclear whether damage 314 and damage 316 correspond to the same physical damage region on vehicle 306 (damage 308) or not, i.e., is there redundancy or not. As such, damage region 318 is referred to as a first candidate region of damage, and damage 320 is referred to as a second candidate region of damage, until the redundancy is resolved.

Embodiments described herein identify redundancy, for example, by identifying features 318 in image 310 and corresponding matching features 320 in image 312. A transformation (e.g., transformation matrix) may be computed between image 310 and 312 according to matching features 318 and 320. The transformation may be applied to first image 310 to generate a transformed first image. A correlation may be computed between second image 312 and the transformed first image. Redundancy of first candidate region of damage 314 and second candidate region of damage 316 may be identified when the correlation is above a threshold.

Referring now back to FIG. 4, the temporal correlation depicted with reference to FIG. 4 may be implemented, for example, as described with reference to 108B of FIG. 1. An image sensor 402 is set relative to a moving vehicle 406 having a region of damage 408 on its side. A first image 410 is captured by image sensor 402 at time T1. A second image 412 is captured by the same image sensor 402 at time T2. Between T1 and T2, vehicle 406 has advanced past image sensor 402, optionally a predefined distance. Damage 408 is depicted as damage 414 in image 410, and as damage 416 in image 412. However, based upon inspection of images 410 and 412, it is unclear whether damage 414 and damage 416 correspond to the same physical damage region on vehicle 406 (damage 408) or not, i.e., is there redundancy or not. As such, damage region 418 is referred to as a first candidate region of damage, and damage 420 is referred to as a second candidate region of damage, until the redundancy is resolved. Embodiments described herein identify redundancy, for example, by predicting the location of first candidate region of damage 414 in second image 412. The prediction may be computed, for example, by applying an image motion approach, for example, applying optical flow to features of first image 410 and/or first candidate damage region 414 for displacement thereof according to the relative movement occurring between the time of capture of first image 414 and second image 416, and the like. For example, when first image 410 and second image 412 are captured about one second apart, during which time the vehicle moved about 10 centimeters past the image sensor, first image 410 and/or first candidate region of damage 414 is displaced an amount of pixels corresponding to 10 centimeters.

Embodiments described herein identify redundancy, for example, by computing a correlation between the predictions of displacement of first candidate region of damage 414 and second candidate region of damage 416. Redundancy of first candidate region of damage 414 and second candidate region of damage 416 may be identified when the correlation is above a threshold.

Referring now back to FIG. 5, features of the method described with FIG. 5 may be implemented, for example, with reference to features 112 and/or 114 described with reference to FIG. 1.

At 502, one or more representations (e.g., images, 3D model) of the vehicle are presented within the user interface (UI), optionally within the GUI.

Optionally, indication(s) of damage each corresponding to a single physical damage area at a certain physical location of the vehicle (computed as described herein) may be visually indicated on the representation of the vehicle, for example, marked by a boundary (e.g., bounding box) and/or color coded, and the like.

Optionally, regions of damaged which are identified as non-redundant may be indicated on the image of the vehicle. The non-redundant regions of damage may be identified, for example, as described with reference to FIG. 1.

Optionally, a 3D representation of the vehicle is presented within the UI. Parameters of the vehicle (e.g., make, model, year, color, and the like) may be mapped to a predefined 3D model of the vehicle, which may be selected from multiple predefined 3D model templates of vehicles.

The representation (e.g., image) of the vehicle may be segmented into multiple components, and/or the segmented components may be predefined. Components may represent separate physically distinct components of the vehicle each of which is individually replaceable, for example, based on a parts catalogue. Alternatively or additionally, components may correspond to clusters and/or classification categories described herein.

The components may be defined on the 3D model, for example, boundaries of the components may be marked. In another example, different individual components may be visually enhanced (e.g., colored, filled in, outlined in bold) in response to hovering with a mouse icon over each respective individual component.

Optionally, the detected region(s) of damage are mapped to the components of the representation (e.g., 3D model, images). The representation (e.g., 3D model, images) with the detected region(s) depicted thereon may be presented within the UI, for example, visually indicated by boundaries, color coding, and the like.

At 504, a selection of a component may be received, via the user interface, for example, the user clicked on a certain component.

At 506, in response to the selection of the component, an indication of one or more detected region of damage to the selected component may be presented within the UI. Alternatively, the detected region(s) of damage are presented on the representation of the vehicle within the UI. In such embodiments, the component with detected region(s) of damage may be presented within the UI in isolation from other components, optionally enlarged to better depict the region(s) of damage.

Optionally, each detected region of damage is depicted by a visual marking, for example, within a boundary (e.g., bounding box, circle), a distinct visual overlay over the damage, an arrow pointing to the damage, and a color coding of the damage (e.g., blue, yellow, or other color different than the color of the body of the vehicle).

Optionally, a single boundary may include multiple detected regions of damage corresponding to a single aggregated damage region. For example, there may be multiple scratches and/or dents which may be fairly close together, arising from a single scrap against a corner of a concrete barrier. The multiple scratches and/or dents may be considered as the single aggregated damage region, for example, due to their proximity and/or distribution indicating they occurred by a same mechanism, and/or due to their proximity and/or distribution indication that they are to be fixed together.

At 508, one or more data items are presented within the UI in response to a selection, via the user interface, of one of the detected regions of damage.

Optionally, in response to a selection of one of the detected regions of damage, via the user interface, an interactive selection box for selection by a user of one or more data item(s) is presented within the user interface. The user may receive additional information regarding the selected data item(s). For example, the interactive selection box is for obtaining additional information for severity of the damage. In another example, the interactive selection box is for a user to mark the detected region(s) of damage, for example, reject or accept the damage as significant or not.

The data item(s) may include at least one parameter of the selected detected region of damage. Examples of parameters include: type of damage (e.g., scratch, dent, superficial, deep), recommendation for fixing the damage (e.g., spot fix, straighten and repaint), indication of whether component is to be replaced or not, physical location of the damage on the component, and estimated cost for repair.

Optionally, in response to a selection of one of the detected regions of damage, via the user interface, an enlarged image of the selected region of damage is presented within the user interface. An image depicting the damage within the selected region of damage may be automatically enlarged and/or the damage may be automatically placed in focus.

At 510, instructions for rotating, displacement, and/or zoom in/out of the representation of the vehicle (e.g., 3D model) are obtained via the UI. The UI may be automatically updated accordingly.

At 512, one or more features described with reference to 502-510 may be iterated, for example, for dynamic updating of the UI in response to interactions by a user.

Referring now back to FIG. 6, schematics 602, 604, 606, and 608 depicting different views of the 3D model of the vehicle presented within the UI. Physical components with identified damage regions may be depicted. For example, a door 610, hood 612, and roof 614 with damage may be indicated, for example, colored. The coloring may be a coding, for example, indicating severity of damage to the physical component. Details of the damage regions may be presented in response to selection of a certain component, for example, as described herein.

Referring now back to FIG. 7, schematics 702, 704, and 706 represent examples of images depicting different images 750, 752, and 754 of a vehicle, each with a respective detected region of damage 708, 710, and 712, optionally presented within a UI. Regions of damage 708, 710, and 712 each represent a single physical damage region for which redundancy has been identified and ignored and/or removed, as described herein. A text description 714, 716, and 718 for each respective region of damage 708, 710, and 712, may be presented within the UI, for example, below the respective image 750, 752, and 754.

Referring now back to FIG. 8, schematics 802, 804, and 806 represent examples of different views and/or zoom levels of a fender of a car with damage 808A-C, optionally presented within a UI. A user may interact with the UI to obtain schematics 802, 804, and 806, and/or other views and/or other zoom levels, which may be of the same region and/or other regions of the vehicle. Damage 808A-C of schematics 802, 804, and 806 are of a same single physical damage region, where redundancy has been identified and/or ignored/removed.

Referring now back to FIG. 9, schematics 902, 904, and 906 represent various levels of interaction of a user with a UI. Schematic 902 depicts an image of a region of a car, including a boundary 908 indicating an identified region of damage, i.e., a non-redundant region of damage, as descried herein. A description 910 (e.g., text) of the location and/or type of damage may be presented. Schematic 904 depicts a zoom-in of the region with damage, optionally a zoom-in of boundary 908 and/or including boundary 908. Schematic 904 may be obtained, for example, in response to a user selecting boundary 908 and/or in response to a user zooming in on boundary 908. Schematic 904 includes another boundary 912 around a physical damage to the car. Schematic 906 includes a zoom-in of boundary 912, and interactive icons 914. For example, icons may represent feedback options for a user, for example, to indicate whether the dent is significant or non-significant. Schematic 906 may be presented, for example, in response to a user selecting boundary 912 on schematic 904.

Referring now back to FIG. 10, image 1002 depicts the vehicle without damage to a bumper 1006. Deepfake image 1004 is created by adapting image 1002, for depicting the same vehicle with damage to the bumper 1008 where no damage 1006 exists to the bumper in image 1002. Image 1004 may be created, for example, by a deepfake tools, such as a deepfake GenAI model. Image 1004 may be maliciously submitted as an insurance claim for damage that does not actually exist. At least one embodiment described herein is designed to detect that image 1004 is deepfake. Inventors created image 1004 through experimentation with readily available generative AI tools, successfully fabricated convincing fraudulent insurance claims, highlighting the case with which these tools can be exploited for malicious purposes. After generating the deepfake image 1004, the Inventors used a different generative AI tool to create a video from the deepfake image 1004. The deepfake video depicts a walk around of the stationary car, showcasing its condition and any potential damage. The video was not a genuine recording of the incident but rather a digitally generated simulation. The seed image used to initiate and guide the deepfake video's creation was deepfake image. This manipulation technique highlights the potential for AI to not only generate static, misleading images but also to produce dynamic, seemingly authentic video evidence, further complicating the challenges of fraud detection in the insurance sector. The use of video further adds to the realism and potential for deception, as it can be more convincing than a static image. This combination of deepfake images and videos generated by AI could be used to support fraudulent insurance claims, making it appear as though damage occurred when it did not. At least one embodiment described herein is designed to detect that the video is deepfake.

Referring now back to FIG. 11, flowchart 1102 is an exemplary high-level method for detection of deepfake data depicting damage to a vehicle, using an AI-powered (i.e., ML model) vehicle inspection, as described herein. After a claim is submitted, an automated scan of the vehicle authenticates the reported damage. If damage is verified, the claim proceeds; if not, the case may be flagged as potential fraud, thereby ensuring claims are based on physical evidence rather than potentially manipulated images.

At 1104, the method may be triggered in response to receiving data associated with a claim for vehicle damage, for example, submitted by a policyholder. The claim may be submitted, for example, through an online portal, mobile app, or by contacting the insurance provider. The claim includes details about the incident, the extent of the damage, and any supporting documentation (e.g., text), such as images (e.g., photos, videos), police reports, and/or other documents.

The submission of the insurance claim may represent a first layer of security, involving the use of a trusted third party to oversee the claims submission process. The trusted third party may ensure that all claims are handled fairly and/or impartially, for reducing the risk of bias and/or collusion.

At 1106, in response to the submitted claim, the policyholder may be instructed to scan the vehicle, for example, at the nearest scanner location. Optionally, an automated message is sent to the policyholder, for example, an email to an email address, a text message to a mobile device, and a pop-up may appear on an online portal of the insurance company when the policyholder accesses it, and the like.

The vehicle is automatically inspected for damage by an AI-powered (e.g., ML model) system that analyzes multiple images of the vehicle, for example, as described herein. The ML model may be trained on a vast dataset of vehicle images and damage assessments, allowing it to accurately identify and classify different types of damage, such as dents, scratches, and broken parts. The ML model may estimate the severity of the damage and/or calculates an approximate repair cost.

The AI model's damage assessment is compared to the data provided by the policyholder in their claim.

The automated scanning process that incorporates multiple cameras and multiple frames to capture detailed images of the vehicle may represent a second layer of security. The automatic scanning process is designed to provide a thorough inspection of the vehicle's condition, identifying any damage or inconsistencies that may indicate fraud.

A third layer of security may be provided by embedding of an encrypted digital fingerprint within the vehicle's image data. This fingerprint serves as a tamper-proof record of the vehicle's condition, making it impossible for fraudsters to alter or manipulate the data without detection. Additional exemplary details of the encrypted digital fingerprint are described below.

At 1108, when the AI model's findings substantially match the reported damage, the claim is considered verified and proceeds to the next stage of the claims process.

Verified claims may be processed according to the insurance company's standard procedures. This typically involves issuing a payment to the policyholder or their chosen repair shop, minus any applicable deductibles.

Alternatively, at 1110, the AI's assessment does not match the reported damage.

At 1112, the data (e.g., images, video, text, documents) is be classified as deepfake, and the claim identified as potential fraud. Alternatively, this could indicate that the policyholder has exaggerated the damage, submitted photos of pre-existing damage, or even attempted to stage an accident. The flagged claim may be, for example, fed into a deepfake detector model for further evidence that the image was created or manipulated by a deepfake tool, automatically labelled to depict the manipulated region of damage (e.g., using a bounding box), and/or automatically routed to a claims investigator for further review (e.g., manual investigation).

Referring now back to FIG. 12, the method for automatically detecting that at least one target image depicting damage to a vehicle is generated or manipulated by deepfake technology, is described. The method described with reference to FIG. 12 may be a more detailed version of the method described with reference to FIG. 11. For example, steps and/or features of the methods described with reference to FIG. 11 and FIG. 12 may be combined, provided as alternatives, interchanged, and/or otherwise adapted accordingly.

At 1202, multiple authentic images depicting a vehicle with actual damage are received (e.g., accessed). The multiple authentic images are captured by image sensors positioned at different heights and/or angles (i.e., different poses) relative to the vehicle. The authentic images may be implemented as the time-spaced image sequences described herein.

Optionally, a cryptographic digital fingerprint is generated for the authentic images, optionally per image. The digital fingerprint may be embedded and/or added to each respective image, for example, as metadata, as an overlay, and/or by adapting pixel intensities of the image itself in a predefined region for the digital fingerprint, for example, the lower right hand corner, the upper right hand corner, and the like. The cryptographic digital fingerprint may be automatically generated by circuitry, for example, installed within each camera capturing an image for generation in combination with the captured image, by a server that receives, the authentic images, by a data storage device that stores the captured images, and the like. The cryptographic digital fingerprint may be generated based on a unique seed associated with each camera, for example, a hardwired serial number of each camera, a geographic location of each camera (e.g., coordinates thereof), and the like.

The cryptographic digital fingerprint may be designed to indicate authenticity of authentic images. Confirmation of the presence of the cryptographic digital fingerprint and/or authentication of the digital fingerprint may be performed prior to feeding into the ML model. For example, a server that receives the authentic image may validate the digital signature by querying the camera for its unique identifier, computing the digital fingerprint, and checking for a match with the digital fingerprint embedded in the image, prior to feeding the image into the locally executing ML model.

At 1204, the authentic images may be processed using one or more approaches described herein, for example, with respect to FIG. 1.

Optionally, the authentic images are implemented as the time-spaced image sequences described herein. Candidate regions of damage are identified the plurality of time-spaced image sequences. Multi-level redundancy validation may be performed by executing spatial correlation between images captured by different images sensors at different heights and/or different angles. Temporal correlation between consecutive images captured by each image sensor may be executed. Persistence of each candidate region of damage across a threshold number of consecutive frames may be validated. Redundancy is identified in the candidate regions of damage corresponding to a common physical location of the vehicle denoting a single physical damage region based on the multi-level redundancy validation. At least one actual image may be selected from the time-spaced image sequences depicting the common physical location of the vehicle corresponding to the single physical damage region. The selected actual image(s) is fed into the ML model to obtain the ground truth set of human-readable text, as described herein.

Alternatively, candidate regions of damage are identified in the time-spaced image sequences. A spatiotemporal correlation is performed between the time-spaced image sequences. Redundancy is identified in the candidate regions of damage corresponding to a common physical location of the vehicle denoting a single physical damage region. At least one actual image is selected from the time-spaced image sequences depicting the common physical location of the vehicle corresponding to the single physical damage region. The selected actual image(s) is fed into the ML model to obtain the ground truth set of human-readable text, as described herein.

At 1206, the authentic images depicting the actual damage to the vehicle, optionally the selected actual image(s), are fed into the ML model. For example, the authentic images are stored in a dedicated location in a memory, and the ML model is instructed to access the dedicated location to extract the authentic images. In another example, the authentic images are accessed by the processor which directly enters the authentic images into an input interface of the ML model.

Alternatively or additionally, a region depicting the damage region is extracted from the authentic images, optionally the region depicts the common physical location corresponding to the physical damage region, and fed into the ML model, rather than feeding the entire image.

At 1208, a ground truth set of human-readable text describing the actual damage to the vehicle depicted in the authentic images is obtained from the ML model. The human-readable text may include a location of the actual damage. For example, as described with reference to 714, 716, and/or 718 of FIG. 7. For example, “Dent on the right rear fender” (see 714 of FIG. 7.

Other examples of human-readable text generated by the ML model in response to an input image depicting damage to the vehicle include:
An indication of severity of damage depicted in the input image, for example, minor damage, medium damage, severe damage.
A recommendation for repair of the damage, optionally according to the severity. For example, repair of the component, or replacement of the component.
An estimated cost for repairing the damage. For example, about $500-$1000 US to replace the damaged bumper, or about $200-$400 to repair the damage on the bumper.

The set of human-readable text describing the potential damage may be generated by the ML model according to a predefined format and/or template. The predefined formation and/or template may be designed for improving accuracy of computing the similarity metric. For example, the similarity metric is computed for each pair of corresponding fields of the template, assigned a predefined weight, and aggregated to obtain a single combined metric.

The ML model may be implemented as, for example, a detector component followed by a classifier.

The detector may analyze images of the vehicle to detect a region of damage. The detector component may output a bounding box delineating the region (e.g., encompassing the region). The detector component may generate an indication of the location of the detected region of damage, for example, based on an analysis of the image, and/or based on a mapping between the pose of the camera that captured the image and the location of the vehicle that the camera is positioned to capture, and/or by detecting features of known components (e.g., door, bumper, window), and the like. The detector may be trained on a training set of images depicting damage to a vehicle marked with ground truth bounding boxes.

The classifier may be fed the image marked with the bounding box, or a patch comprising the bounding box may be extracted and fed into the classifier. The classifier may generate a classification category indicating a text description of the damage and/or severity of the damage. The classifier may be trained on images and/or patches of images labelled with ground truth text descriptions of the depicted damage.

Alternatively, the ML model may be implemented as a single architecture that directly outputs the human-readable text. The ML model may be trained on a training dataset of a records, where a record may includes at least one image of a sample vehicle indicating sample damage, and a ground truth including a set of human-readable text elements describing the damage.

At 1210, at least one target image depicting potential damage to the vehicle is received. The at least one target image is received for evaluation of being deepfake, for example, created by a deepfake tool and/or adaptation of an original image by the deepfake tool. Examples of deepfake target images include an image of a car that does not have any damage (or significant damage) that is adapted to depict a region of damage requiring repair (e.g., dent in a bumper, scratch on a door). In another example, the deepfake image is created by adapting an image of a car with actual damage, by replacing the license plate of the damaged car with the license plate of another car that does not have any actual damage.

The target image(s) may be submitted as part of an insurance claim, for example, submitted via an online portal, by email, and the like.

Optionally, a target human-readable text description of the potential damage is received in association with the target images, for example, a template form that is filled out by the person filling the insurance claim that describes the accident and damage, and the like.

At 1212, the target image is fed into the ML model. The target image may be fed into the same ML model which is fed the authentic images. The feeding may be at different times, to distinguish the outcomes.

Optionally, the target human-readable text description of the potential damage is fed into the ML model in combination with the target image(s).

At 1214, a candidate set of human-readable text describing the potential damage to the vehicle depicted in the target image is obtained from the ML model. The human-readable text may include the location of the potential damage depicted in the target image. Other exemplary features related to the ML model are described, for example, with reference to 1208.

At 1216, a similarity metric indicating a difference between the potential damage described in the candidate set of human-readable text generated by the ML model in response to the input of the target image(s), and the actual damage described in the ground truth set of human-readable text generated by the ML model in response to the input of the authentic image(s), is computed.

The similarity metric may be computed, for example, by:
Feeding the potential damage described in the candidate set of human-readable text and the actual damage described in the ground truth set of human-readable text into a second ML model trained to generate an outcome indicating whether two inputs are similar or not and/or generate an indication of a level of dissimilarity. The second ML model may implemented as a large language model (LLM). A prompt may be automatically generated and/or fed into the LLM for instructing the LLM model to identify and describe the difference between the potential damage described in the candidate set of human-readable text and the actual damage described in the ground truth set of human-readable text.
As a correlation value indicating correlation between the candidate set of human-readable text and the actual damage described in the ground truth set of human-readable text. When the candidate set of human-readable text and the actual damage described in the ground truth set of human-readable text are each inserted into a common template, the similarity metric may be computed, for example, per field, and/or as an aggregation of sub-similarity metrics computed for each field and optionally weighed.
Computed as a statistical distance, for example, Euclidean distance, between a first point in space representing the described potential damage and a second point in space representing the described actual damage. The two points may be vector representations of their corresponding descriptions, which may be generated by an encoder (e.g., neural network) fed the corresponding descriptions.

The flow described herein, of first generating the set of human-readable text for the image (the authentic image and/or the target image), and then computing the similarity metric may provide the following potential advantages:
Increased accuracy in comparison to computing a correlation between the authentic image and the target image. The accuracy in comparing directly between the two images may be decreased, for example, due to the differences in the two images captured at different poses, different cameras, different lighting conditions, etc. The accuracy may be improved since the location and extent of the damage is initially evaluated, rather than trying to find and compare damage in two images. The comparisons may be incorrect, for example, between damage and a light pattern that appears as damage but isn't, between pre-existing damage in two different locations, and the like.
The human-readable text enables a human to verify the damage, and/or provides easy to understand evidence for fraud.
Improved computational efficiency of the processor executing the ML models, by focusing on the specific identified damage rather than trying to correlate between vehicles captured at different camera poses and/or difficult lighting conditions which requires computation of a 3D rotational matrix for alignment and/or registration of 3D vehicles.

At 1218, in response to the similarity metric indicating a difference being above a threshold or meeting a requirement indicating a significant difference, the target image is identified as likely deepfake. For example, the description of the actual damage indicates no damage, and the description of the potential damage in the target image indicates medium damage in the form of a dent to the left side of the front bumper.

At 1220, one or more actions may be implemented in response to detecting that the target image is likely deepfake:
Feeding the target image(s) into a deepfake detection process that analyzes the target image(s) to confirm that the target image has been created or modified by a deepfake tool. The deepfake detector may generate, for example, a bounding box indicating the region of an original image that was manipulated (which is expected to corresponding to the region of damage), and/or a description of the manipulation that was performed, and/or a description of how the manipulation was performed.
Forwarding the target image(s) and/or the associated provided description to an automated processes (e.g., another ML model) for detecting fraud. For example, the damage depicted in the image may indicate minor damage, whereas the text description may indicate a crash at high speed which is expected to yield severe damage.
Forwarding to a queue for manual inspection by a claims fraud expert.

Alternatively to 1218, at 1222, in response to the similarity metric indicating a difference being below a threshold or meeting a requirement indicating a non-significant difference, the target image is identified as likely authentic. For example, the description of the actual damage indicates medium damage in the form of a dent to the left side of the front bumper, and the description of the potential damage in the target image indicates minor damage in the form of a dent to the left side of the front bumper, or medium damage to the middle of the front bumper, and the like.

At 1224, one or more actions may be implemented in response to detecting that the target image is likely authentic, for example, providing an indication of authenticity to an automated process that automatically processes and approves the submitted claims.

Referring now back to FIG. 13, pre-existing damage to a vehicle may be detected for identifying insurance fraud of an attempt to try to claim the pre-existing damage. The method described with reference to FIG. 13 may be an adaptation of the method described with reference to FIG. 12. Features 1202-1208 are as described with reference to FIG. 12.

At 1310, a historical set of authentic images of the vehicle depicting pre-existing damage or lack of damage, is accessed. For example, the historical set is stored on a data storage device based on images captured by cameras described herein during a historical imaging session, for example, for a prior insurance claim evaluation, automated damage inspection, and the like.

At 1312, the historical set of authentic images are fed into the ML model.

At 1314, a historical set of human-readable text describing pre-existing damage to the vehicle or lack of damage to the vehicle is obtained from the ML model.

At 1316, the second similarity metric is computed for indicating similarity between the pre-existing damage or lack of damage of the vehicle described in the historical set of human-readable text and the actual damage described in the ground truth.

At 1318, in response to the second similarity metric being above a threshold indicating high similarity the presence of pre-existing damage to the vehicle is confirmed. The pre-existing damage may indicate an attempt at fraud when the claim is directed to the pre-existing damage.

At 1320, an indication of the pre-existing damage may be automatically generated and sent, for example, to a server of the insurance company for detecting potential fraud. Alternatively, the pre-existing damage is excluded from the claim for other new damage.

Alternatively, at 1322, in response to the second similarity metric being below the threshold indicating lack of similarity, the lack of pre-existing damage to the vehicle may be confirmed.

At 1324, an indication of no pre-existing damage may be generated. The indication may be forwarded, for example, to the server of the insurance company, for example, for confirming the presence of the existing damage as being new, such as for automated approval of the insurance claim.

Referring now back to FIG. 14, the features of the method described with reference to FIG. 14 may be implemented by, and/or integrated with, the features of the method described with reference to FIG. 12. For example, the method described with reference to FIG. 14 represents additional features that use the authentic images to help confirm that the target image detected by the method described with reference to FIG. 12 is deepfake. Alternatively, the method described with reference to FIG. 14 may be used alone to help detect that the target image is deepfake.

Features 1202, 1204, 1210, 1212, and 1214, are performed as described with reference to FIG. 12.

At 1410, at least one image is selected from the authentic images. The image is selected for depicting at least one region of the vehicle with damage not depicted in the target image(s). For example, the region(s) depicted in the selected image includes an undercarriage captured by at least one image sensor positioned for capturing images depicting the undercarriage of the vehicle. In another example, the region(s) depicted in the selected image and not depicted in the authentic image includes, for example, the driver side, the passenger side, the front, the back, a corner, a door excluding the window, the window excluding the bottom part of the door, and the like.

At 1412, the selected image is analyzed for compliance with a damage pattern that is depicted by the target image. The selected image is analyzed to check that the damage pattern depicted in the region of the vehicle that is not depicted in the target image complies with the damage pattern that is depicted in the target image.

The selected image may be analyzed by feeding into the ML model. Optionally, the region of the vehicle with damage not depicted in the target image(s) is extracted from the

At 1414, a ground truth set of human-readable text describing the damage in the region of the selected image that is not depicted in the target image, is obtained from the ML model. The set of human-readable text is as described with reference to FIG. 12 and/or FIG. 13.

At 1416, the ground truth set may be analyzed, optionally with respect to the candidate set of human-readable text generated for the target image, as described with reference to 1214 of FIG. 12.

The analysis may be performed by feeding into another ML model, optionally a LLM, trained on records. Each record includes a description of a damage pattern and an indication of whether the damage pattern is likely or unlikely. In another example, the analysis may be performed by evaluation using a set of rules defining likely or unlikely damage patterns. In yet another example, the analysis may be performed by feeding the ground truth set (from 1414) and the candidate set (from 1214) into a physical simulation model that simulates an accident according to input. The physical simulation model may simulate the accident described in the input data and as depicted in the target image(s), to determine whether the predicted simulated damage is similar to (or matches) the damage pattern depicted in the region of the actual damage that is not depicted in the target image.

At 1418, in response to detecting that the damage in the region of the selected image is inconsistent with and/or contradicts the damage pattern depicted by the target image, the target image is identified and/or confirms as likely deepfake.

Alternatively, as 1422, in response to detecting that the damage in the region of the selected image is consistent with the damage pattern depicted by the target image, the target image is identified and/or confirms as likely authentic.

Various embodiments and aspects of the present disclosure as delineated hereinabove and as claimed in the claims section below find experimental support in the following examples.

### EXAMPLES

Reference is now made to the following example, which together with the above descriptions illustrate some embodiments of the invention in a non limiting fashion.

Inventors partnered with an insurance provider to pilot an automated inspection workflow that demonstrates how at least one embodiment described herein translates into measurable claims-handling improvements, in terms of detection of deepfake images and/or other data potentially indicating claim fraud.

### Program Design

Drive-through convenience. Customers simply drive through a scanning system installed at participating dealerships. The scan is completed in seconds, and the customer can leave immediately, eliminating the traditional delays of uploading photos or waiting for an in-person appraisal.
High-fidelity evidence. The multi-camera, multi-frame scan produce a comprehensive, high-resolution image set including under-body views that is automatically transmitted to the insurance company's appraisers.
Fraud resistance. Because the imagery is captured by a trusted third-party scanner and cryptographically signed, there is no opportunity for customers to manipulate photos or omit angles that would reveal prior, unrelated damage.

### Early Results

The Director of Auto Physical Damage Claims at the insurance company, notes:

“Our appraisers remark that they would be unlikely to see the damage in such detail in the field, particularly underneath the vehicle, which often would result in the need for re-inspection and a supplemental estimate once the vehicle was in a repair shop and up on a lift.”

The pilot has already:
Reduced cycle time by removing supplemental inspections.
Identified prior or unrelated damage early, avoiding improper payouts.
Matched or exceeded estimate accuracy compared with conventional field appraisals.

### Next Steps

The partners are exploring the use of the system described herein to generate real-time, fully costed estimates in suitable cases. As Taylor explains:

“Think of the gains in turn-around time if a customer can simply drive through a scanning system and have a completed appraisal ready almost instantaneously! This could be a game-changer for auto-claim cycle time, and in turn, a huge boost for customer service.”

This experience illustrates how embedding scans in the claims workflow not only deters fraud but also accelerates genuine claims, delivering a better experience for both insurer and policyholder.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant image sensors will be developed and the scope of the term image sensor is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for automatically detecting that at least one target image depicting damage to a vehicle is generated or manipulated by deepfake technology, comprising:
a plurality of image sensors positioned at a plurality of different heights and/or angles relative to the vehicle configured for capturing a plurality of authentic images depicting a vehicle with actual damage;
a data interface configured to access and/or receive at least one target image depicting potential damage to the vehicle for evaluation of being deepfake;
at least one processor configured for:
feeding into a machine learning (ML) model, the at least one target image;
obtaining from the machine learning model, a candidate set of human-readable text describing the potential damage to the vehicle depicted in the at least one target image;
feeding into the ML model, the plurality of authentic images depicting the actual damage to the vehicle;
obtaining from the ML model, a ground truth set of human-readable text describing the actual damage to the vehicle depicted in the authentic images;
computing a similarity metric indicating a difference between the potential damage described in the candidate set of human-readable text and the actual damage described in the ground truth set of human-readable text; and
in response to the difference being above a threshold or meeting a requirement indicating a significant difference, detecting that the at least one target image is likely deepfake.

2. The system of claim 1, wherein the at least one processor is further configured for: in response to the generated indication that the at least one target image is likely deepfake, feeding the at least one target image into a deepfake detection process that analyzes the at least one target image to confirm that the at least one target image is deepfake.

3. The system of claim 1, wherein the at least one processor is further configured for: generative a cryptographic digital fingerprint indicating authenticity associated with the plurality of authentic images, and for confirming presence of the cryptographic digital fingerprint for validating authenticity of the plurality of authentic images prior to feeding into the ML model.

4. The system of claim 1, wherein the data interface is further configured to access and/or receive a target human-readable text description of the potential damage, wherein the target human-readable text description of the potential damage is fed into the ML model in combination with the at least one target image.

5. The system of claim 1, wherein the ML model generates at least one of the following in response to an input image depicting damage to the vehicle: (i) an indication of severity of damage depicted in the input image, (ii) a recommendation for repair of the damage, and (iii) an estimated cost for repairing the damage.

6. The system of claim 1, wherein the similarity metric is computed by feeding the potential damage described in the candidate set of human-readable text and the actual damage described in the ground truth set of human-readable text into a second ML model trained to generate an outcome indicating whether two inputs are similar or not and/or generate an indication of a level of dissimilarity.

7. The system of claim 6, wherein the second ML model is implemented as a large language model (LLM), wherein a prompt is fed into the LLM for instructing the LLM model to identify and describe the difference between the potential damage described in the candidate set of human-readable text and the actual damage described in the ground truth set of human-readable text

8. The system of claim 1, wherein in response to an input image depicting damage, the ML model generates an outcome of a set of human-readable text describing the potential damage according to a predefined format and/or template selected for improving accuracy of computing the similarity metric.

9. The system of claim 1, wherein the ML model is trained on a training dataset of a plurality of records, wherein a record includes at least one image of a sample vehicle indicating sample damage, and a ground truth including a set of human-readable text elements describing the damage.

10. The system of claim 1, wherein the at least one processor is further configured for:
accessing a historical set of authentic images of the vehicle depicting pre-existing damage or lack of damage;
feeding into the ML model, the historical set of authentic images;
obtaining from the ML model, a historical set of human-readable text describing pre-existing damage to the vehicle or lack of damage to the vehicle;
computing a second similarity metric indicating similarity between the pre-existing damage or lack of damage of the vehicle described in the historical set of human-readable text and the actual damage described in the ground truth; and
(i) in response to the second similarity metric being above a threshold, confirming the presence of pre-existing damage to the vehicle, or
(ii) in response to the second similarity metric being below the threshold, confirming the lack of pre-existing damage to the vehicle.

11. The system of claim 1, wherein the at least one processor is further configured for:
selecting at least one image of the plurality of authentic image depicting at least one region of the vehicle with damage not depicted in the at least one target image;
analyzing the selected at least one image for compliance with a damage pattern depicted by the at least one target image; and
in response to detecting that the damage in the at least one region of the selected at least one image is inconsistent with and/or contradicts the damage pattern depicted by the at least one target image, detecting that the at least one target image is likely deepfake.

12. The system of claim 11, wherein the at least one region comprises an undercarriage captured by at least one image sensor positioned for capturing images depicting the undercarriage of the vehicle.

13. The system of claim 11, wherein the analyzing is performed by:
feeding the selected at least one image into the ML model;
obtaining from the ML model, a second ground truth set of human-readable text describing the damage in the at least one region not depicted in the at least one target image;
and analyzing the second ground truth set with respect to the candidate set by at least one of: feeding into a second ML model and/or a LLM trained on a plurality of records where each record includes a description of a damage pattern and an indication of whether the damage pattern is likely or unlikely, a set of rules defining likely or unlikely damage patterns, feeding the second ground truth set and the candidate set into a model that simulates an accident according to input.

14. The system of claim 1, wherein the plurality of authentic images comprise a plurality of time-spaced image sequences,
wherein the at least one processor is further configured for:
identifying a plurality of candidate regions of damage in the plurality of time-spaced image sequences;
performing multi-level redundancy validation by:
executing spatial correlation between images captured by different images sensors at different heights and/or different angles,
executing temporal correlation between consecutive images captured by each image sensor, and
validating persistence of each candidate region of damage across a threshold number of consecutive frames;
identifying redundancy in the plurality of candidate regions of damage corresponding to a common physical location of the vehicle denoting a single physical damage region based on the multi-level redundancy validation; and
selecting at least one authentic image from the plurality of time-spaced image sequences depicting the common physical location of the vehicle corresponding to the single physical damage region,
wherein the selected at least one authentic image is fed into the ML model to obtain the ground truth set.

15. The system of claim 1, wherein the plurality of authentic images comprise a plurality of time-spaced image sequences,
wherein the at least one processor is further configured for:
identifying a plurality of candidate regions of damage in the plurality of time-spaced image sequences;
performing a spatiotemporal correlation between the plurality of time-spaced image sequences;
identifying redundancy in the plurality of candidate regions of damage corresponding to a common physical location of the vehicle denoting a single physical damage region; and
selecting at least one actual image from the plurality of time-spaced image sequences depicting the common physical location of the vehicle corresponding to the single physical damage region,
wherein the selected at least one actual image is fed into the ML model to obtain the ground truth set.

16. A method of automatically detecting that at least one target image depicting damage to a vehicle is generated or manipulated by deepfake technology, comprising:
receiving a plurality of authentic images depicting a vehicle with actual damage captured by a plurality of image sensors positioned at a plurality of different heights and/or angles relative to the vehicle;
receiving at least one target image depicting potential damage to the vehicle for evaluation of being deepfake;
feeding into a machine learning (ML) model, the at least one target image;
obtaining from the machine learning model, a candidate set of human-readable text describing the potential damage to the vehicle depicted in the at least one target image;
feeding into the ML model, the plurality of authentic images depicting the actual damage to the vehicle;
obtaining from the ML model, a ground truth set of human-readable text describing the actual damage to the vehicle depicted in the authentic images;
computing a similarity metric indicating a difference between the potential damage described in the candidate set of human-readable text and the actual damage described in the ground truth set of human-readable text; and
in response to the difference being above a threshold or meeting a requirement indicating a significant difference, detecting that the at least one target image is likely deepfake.

17. A non-transitory medium storing program instructions for automatically detecting that at least one target image depicting damage to a vehicle is generated or manipulated by deepfake technology, comprising program instructions which when executed by at least one processor, cause the at least one processor to:
receive a plurality of authentic images depicting a vehicle with actual damage captured by a plurality of image sensors positioned at a plurality of different heights and/or angles relative to the vehicle;
receive at least one target image depicting potential damage to the vehicle for evaluation of being deepfake;
feed into a machine learning (ML) model, the at least one target image;
obtain from the machine learning model, a candidate set of human-readable text describing the potential damage to the vehicle depicted in the at least one target image;
feed into the ML model, the plurality of authentic images depicting the actual damage to the vehicle;
obtain from the ML model, a ground truth set of human-readable text describing the actual damage to the vehicle depicted in the authentic images;
compute a similarity metric indicating a difference between the potential damage described in the candidate set of human-readable text and the actual damage described in the ground truth set of human-readable text; and
in response to the difference being above a threshold or meeting a requirement indicating a significant difference, detect that the at least one target image is likely deepfake.
